(19) United States
(12) Patent Application Publication
(10) Pub. No.: US 2019/0025409 A1
(43) Pub. Date: Jan. 24, 2019

(54) LASER RADAR DEVICE AND TRAVELING BODY

(71) Applicant: MITSUBISHI HEAVY INDUSTRIES, LTD., Tokyo (JP)

(72) Inventors: Kohei KAWAZOE, Tokyo (JP); Takahiro KUBOTA, Tokyo (JP)

(21) Appl. No.: 16/068,131

(22) PCT Filed: Aug. 3, 2016
(86) PCT No.: PCT/JP2016/072835

§ 371 Date: Jul. 5, 2018

(30) Foreign Application Priority Data
Feb. 25, 2016 (JP) 2016-034661

(51) Int. Cl. G01S 7/481; G01S 17/89; G01S 17/93; G01C 15/00; G01S 7/48; G01S 7/484; G01S 7/486; G01S 7/487

(52) U.S. Cl. CPC G01S 7/4817; G01S 17/89; G01S 17/936; G01C 15/002; G01S 7/4873; G01S 7/484; G01S 7/4861; G01S 7/4868; G01S 7/4808

(57) ABSTRACT

A laser radar device includes a radiation shape control unit. The radiation shape control unit performs control such that the radiation shape of laser light L can be changed between a first radiation shape having a small radiation surface area, and a second radiation shape having a large radiation surface area. In accordance with the radiation shape controlled by the radiation shape control unit, the laser radar device causes the laser light to scan and irradiate an area to be measured, receives reflected light from the area to be measured, and generates three-dimensional information relating to the area to be measured on the basis of the received reflected light.

### TECHNICAL FIELD

The present invention relates to a laser radar device that generates three-dimensional information of a measurement-target area by performing scanning with laser light, and a traveling body.

### BACKGROUND ART

Generally, laser radar devices have been known which scan and irradiate a measurement-target area with laser light, and generate three-dimensional information of the measurement-target area from the distribution of light receiving signals obtained by receiving reflected light from an object or the like, present in this measurement-target area, using a light receiving element.

This kind of laser radar device is used in order to detect an obstacle in the forward traveling direction of a traveling body such as a vehicle (see PTL 1). PTL 1 proposes a technique for detecting an obstacle from both near and far using one light-emitting source. Specifically, PTL 1 discloses a technique for setting a short-distance region having a first spread angle within a range of a first predetermined distance or less, and a long-distance region having a second spread angle narrower than the first spread angle within a range of the first predetermined distance or greater and a second predetermined distance or less, and increasing the first spread angle during a decrease in the field of view.

### CITATION LIST

### Patent Literature

[PTL 1] Japanese Patent No. 3330624

### SUMMARY OF INVENTION

### Technical Problem

This kind of laser radar device is required to be able to detect an obstacle under various environments assumed outdoors in a case of being used outdoors such as a case of being used with the device mounted onto a traveling body such as a vehicle. However, the configuration of PTL 1 has a problem in that, in a case where the transmittance of a beam of laser light decreases concomitant with changes in the outdoor environment, even the intensity of reflected light of the laser light decreases, and it is thus difficult to detect an obstacle. In addition, there is a problem in that, in a case where output of a beam of the laser light is raised in order to cope with this difficulty, excessive specification is caused under the environment in which the transmittance of a beam of laser light is high, and the power consumption of the device thus becomes higher.

The present invention is contrived in view of such circumstances, and an object thereof is to provide a laser radar device and a traveling body that make it possible to detect an obstacle while limiting the power consumption of the device even in a case where the transmittance of a beam of laser light changes concomitant with changes in the outdoor environment.

### Solution to Problem

In order to solve the above-mentioned problem and to achieve the object, according to the present invention, there is provided a laser radar device including: a laser light source; a light-transmission-side optical system that forms laser light which is emitted from the laser light source into a first radiation shape or a second radiation shape having a larger radiation surface area than that of the first radiation shape; a radiation shape control unit that controls the light-transmission-side optical system to thereby control a radiation shape for forming the laser light into the first radiation shape or the second radiation shape; a radiation scanner that scans and irradiates a measurement-target area in accordance with the radiation shape with the laser light formed by the light-transmission-side optical system; a light-reception-side optical system that receives and condenses reflected light which is reflected from the measurement-target area; a light reception unit that receives the reflected light condensed by the light-reception-side optical system, and outputs a received signal based on laser light included in the received reflected light; and an information generation unit that generates three-dimensional information of the measurement-target area on the basis of the received signal which is output by the light reception unit.

According to this configuration, the radiation shape of the laser light is changeably controlled between the first radiation shape having a small radiation surface area and the second radiation shape having a large radiation surface area. Therefore, even in a case where the transmittance of a beam of the laser light changes concomitant with changes in the outdoor environment, it is possible to detect an obstacle while limiting the power consumption of the device.

In this configuration, it is preferable to further include a surrounding environment detection unit that detects a range of visibility in a radiation direction of the laser light, and preferable that the radiation shape control unit controls the radiation shape into the first radiation shape in a case where it is determined that the range of visibility in the radiation direction of the laser light detected by the surrounding environment detection unit is less than a threshold value, and controls the radiation shape into the second radiation shape in a case where it is determined that the range of visibility in the radiation direction of the laser light is equal to or greater than the threshold value. According to this configuration, it is possible to control the radiation shape of the laser light on the basis of an objective range of visibility even under a situation such as during uprise of the device.

Alternatively, it is preferable that the light reception unit transmits information of an intensity of the received signal to the radiation shape control unit, and that the radiation shape control unit measures the range of visibility in the radiation direction of the laser light on the basis of the information of an intensity of the received signal, changes the radiation shape from the first radiation shape to the second radiation shape in a case where a peak value of an intensity of the received signal is set to be equal to or greater than a first threshold value in a state where the radiation shape of the laser light is formed into the first radiation shape and irradiation is performed, and changes the radiation shape from the second radiation shape to the first radiation shape in a case where the intensity of the received signal at a predetermined position on an end portion of the light reception unit is set to be less than a second threshold value in a state where the radiation shape of the laser light is formed into the second radiation shape and irradiation is performed. According to this configuration, it is possible to detect an obstacle in quick response to changes in the outdoor environment while limiting the power consumption of the device.

In addition, in these configurations, it is preferable that the light-transmission-side optical system includes an insertion-extraction optical element that switches a state of being disposed on an optical path of the laser light and a state of not being disposed thereon, to thereby switch the radiation shape of the laser light between the first radiation shape and the second radiation shape. According to this configuration, it is possible to simply and reliably switch the radiation shape of the laser light.

In addition, in a configuration in which the insertion-extraction optical element is included, it is preferable that the light-transmission-side optical system forms the radiation shape into the first radiation shape in a state where the insertion-extraction optical element is not disposed on the optical path of the laser light, and forms the radiation shape into the second radiation shape by the insertion-extraction optical element being disposed on the optical path. According to this configuration, it is possible to more simply and reliably switch the radiation shape of the laser light. In addition, it is possible to appropriately select the second radiation shape by selecting the insertion-extraction optical element.

In addition, in a configuration in which the light-transmission-side optical system forms the radiation shape into the second radiation shape by the insertion-extraction optical element being disposed on the optical path, it is preferable that the insertion-extraction optical element is an element that diffuses a beam of the laser light. According to this configuration, it is possible to simply control the second radiation shape in the shape of the insertion-extraction optical element.

Alternatively, in a configuration in which the light-transmission-side optical system forms the radiation shape into the second radiation shape by the insertion-extraction optical element being disposed on the optical path, it is preferable that the insertion-extraction optical element is an element that condenses a beam of the laser light, and forms the laser light which is transmitted into the second radiation shape by diffusing the light beam after condensation, and that the radiation scanner has an optical element constituting the radiation scanner disposed away from a region in which the laser light is condensed. According to this configuration, it is possible to efficiently use the entirety of a beam of the laser light diffused as a result by the insertion-extraction optical element. In addition, According to this configuration, it is possible to prevent an optical element constituting the radiation scanner from being damaged due to the condensed laser light.

In addition, in these configurations, it is preferable that the first radiation shape is a dot shape, and that the radiation scanner scans and irradiates the measurement-target area with the laser light formed into the dot shape which is the first radiation shape, in a first direction of the measurement-target area and a second direction orthogonal to the first direction. According to this configuration, in a case where the radiation shape of the laser light is formed into the first radiation shape, it is possible to maximize the intensity of a beam of the laser light.

In addition, in these configuration, it is preferable that the second radiation shape is a line shape extending in a first direction of the measurement-target area, and that the radiation scanner scans and irradiates the measurement-target area with the laser light formed into the line shape which is the second radiation shape, in a second direction orthogonal to the first direction. According to this configuration, since the second radiation shape has a larger radiation surface area than that of the first radiation shape, a three-dimensional measurement rate for the measurement-target area improves, and thus it is possible to measure the measurement-target area A in a short period of time. In addition, the first direction and the second direction can be separately acquired from the light reception unit and the radiation scanner, respectively, with respect to position information of the laser light included in reflected light to be received, and thus it is possible to measure the measurement-target area with a high level of accuracy.

In addition, in a configuration in which the second radiation shape is a line shape extending in the first direction of the measurement-target area, it is preferable that the light-transmission-side optical system is configured such that an inversion optical system that inverts an intensity distribution of the laser light before or after being formed into a line shape in a direction of the line shape includes a plurality of intensity distribution reduction mechanisms arranged at intervals equivalent to a thickness of the inversion optical system in a direction perpendicular to a radiation direction of the laser light and the direction of the line shape, and that the inversion optical system includes: three first mirror members which are disposed at an inclination of 45 degrees on one side in the direction of the line shape with respect to the radiation direction of the laser light, are of such a length as to cover half an optical path width of the laser light in the direction of the line shape, are lined up in the direction of the line shape, and are respectively disposed so that one first mirror member covers a region shifted from the one side at the optical path width of the laser light in the direction of the line shape, so that one first mirror member covers one half region at the optical path width of the laser light in the direction of the line shape, and so that one first mirror member covers the other half region on an opposite side to the one side at the optical path width of the laser light in the direction of the line shape; and two second mirror members which are provided on a side in the radiation direction of the laser light with respect to two of the first mirror members located on both ends among the three first mirror members, are disposed at an inclination of 45 degrees on the other side in the direction of the line shape with respect to the radiation direction of the laser light, and are of such a length as to cover half the optical path width of the laser light in the direction of the line shape. According to this configuration, the intensity distribution of the laser light formed into a line shape in the direction of the line shape can be reduced, and thus it is possible to improve the accuracy of detection of an obstacle in a case where the laser light formed into a line shape is used.

In addition, in these configurations, it is preferable that the light reception unit includes a light reception region of the reflected light condensed by the light-reception-side optical system. According to this configuration, the light reception unit can receive the reflected light of the entirety of the measurement-target area without performing scanning on the light reception side regardless of the radiation shape of the laser light. Alternatively, in these configurations, it is preferable to further include a light receiving scanner that receives the reflected light reflected from the measurement-target area while performing scanning with the reflected light in accordance with the radiation shape. According to this configuration, since scanning on the light reception side can also be performed in accordance with scanning on the light transmission side, it is possible to receive the reflected light of the entirety of the measurement-target area even in a case where the light reception unit does not include a light reception region of the reflected light condensed by the light-reception-side optical system.

In addition, the above-described laser radar device may be mounted onto a traveling body. According to this configuration, the laser radar device makes it possible to detect an obstacle while limiting the power consumption of the device even in a case where the transmittance of a beam of laser light changes concomitant with changes in the outdoor environment. Therefore, it is possible to acquire three-dimensional information of the traveling route of the traveling body at all times, and to perform driving support of the traveling body.

### Advantageous Effects of Invention

According to the present invention, it is possible to provide a laser radar device and a traveling body that make it possible to detect an obstacle while limiting the power consumption of the device even in a case where the transmittance of a beam of laser light changes concomitant with changes in the outdoor environment.

### BRIEF DESCRIPTION OF DRAWINGS

FIG. 1 is a schematic configuration diagram when a laser radar device according to a first embodiment of the present invention forms laser light into a first radiation shape and performs light irradiation.

FIG. 2 is a schematic configuration diagram when the laser radar device according to the first embodiment of the present invention forms laser light into a second radiation shape and performs light irradiation.

FIG. 3 is a graph illustrating a relationship between the range of visibility and the transmittance of laser light.

FIG. 4 is a schematic configuration diagram when a light-transmission-side optical system forms laser light into the first radiation shape.

FIG. 5 is a schematic configuration diagram when the light-transmission-side optical system forms laser light into the second radiation shape.

FIG. 6 is a schematic diagram illustrating an example of a peripheral configuration including a light-reception-side optical system and a light receiving element.

FIG. 7 is a perspective view illustrating an example of a peripheral configuration including the light-reception-side optical system and the light receiving element.

FIG. 8 is a diagram illustrating a modification example of the light receiving element.

FIG. 9 is a flow diagram of an example of processing of the laser radar device according to the first embodiment of the present invention.

FIG. 10 is a schematic configuration diagram when a laser radar device according to a second embodiment of the present invention forms laser light into the first radiation shape and performs light irradiation.

FIG. 11 is a schematic configuration diagram when the laser radar device according to the second embodiment of the present invention forms laser light into the second radiation shape and performs light irradiation.

FIG. 12 is a schematic configuration diagram of an intensity distribution reduction mechanism provided in a light-transmission-side optical system of a laser radar device according to a third embodiment of the present invention.

FIG. 13 is a diagram illustrating the intensity distribution reduction mechanism.

FIG. 14 is a diagram schematically illustrating a light-transmission-side optical system and a radiation scanner of a laser radar device according to a fourth embodiment of the present invention.

FIG. 15 is a diagram schematically illustrating the light-transmission-side optical system and the radiation scanner of the laser radar device according to the fourth embodiment of the present invention.

FIG. 16 is a diagram schematically illustrating the light-transmission-side optical system and the radiation scanner of the laser radar device according to the fourth embodiment of the present invention.

FIG. 17 is a perspective view illustrating a configuration in which the laser radar device is mounted onto a train traveling on a railroad track.

FIG. 18 is a side-view diagram illustrating a configuration in which the laser radar device is mounted onto the train traveling on the railroad track.

FIG. 19 is a perspective view illustrating a configuration in which the laser radar device is mounted onto a vehicle.

### DESCRIPTION OF EMBODIMENTS

Hereinafter, an embodiment according to the present invention will be described in detail with reference to the accompanying drawings. Meanwhile, it is not intended that the invention is not limited to this embodiment. In addition, components in the embodiment include components which are easily replaceable by those skilled in the art or substantially the same components. Further, components described below can be appropriately combined.

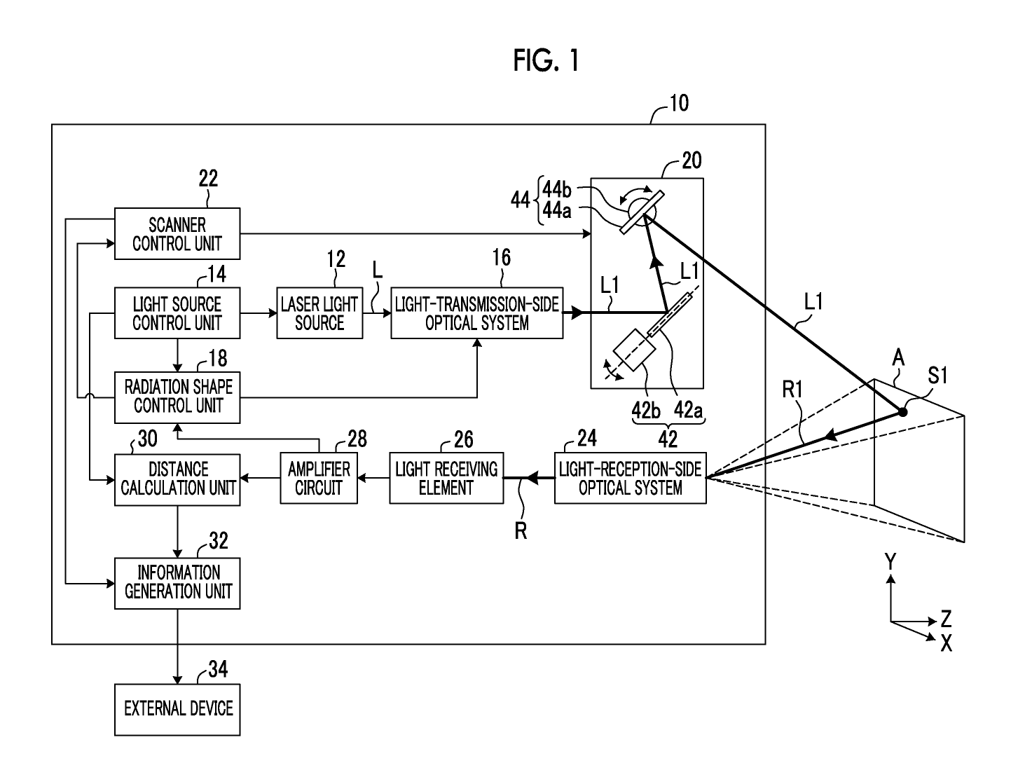

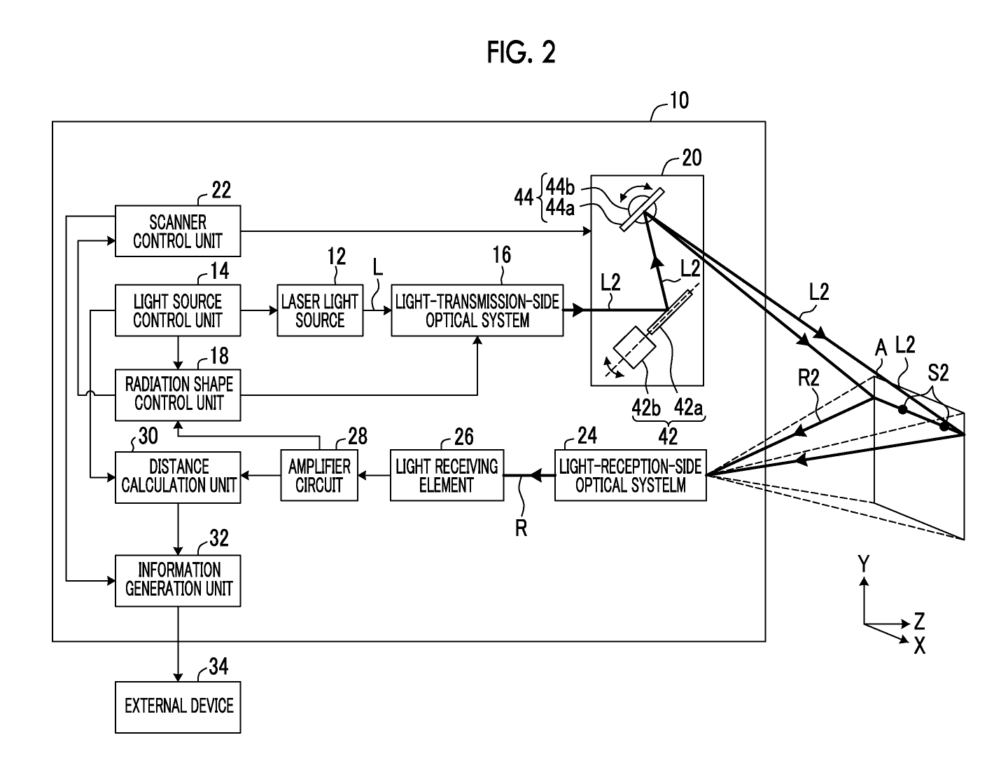

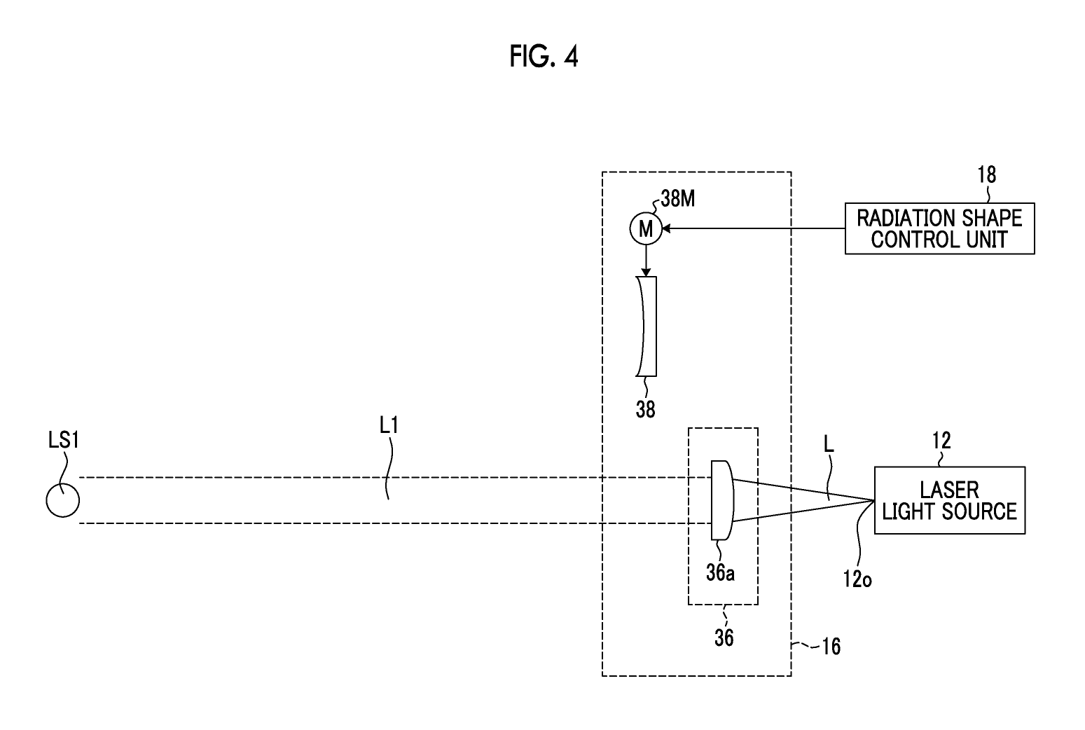

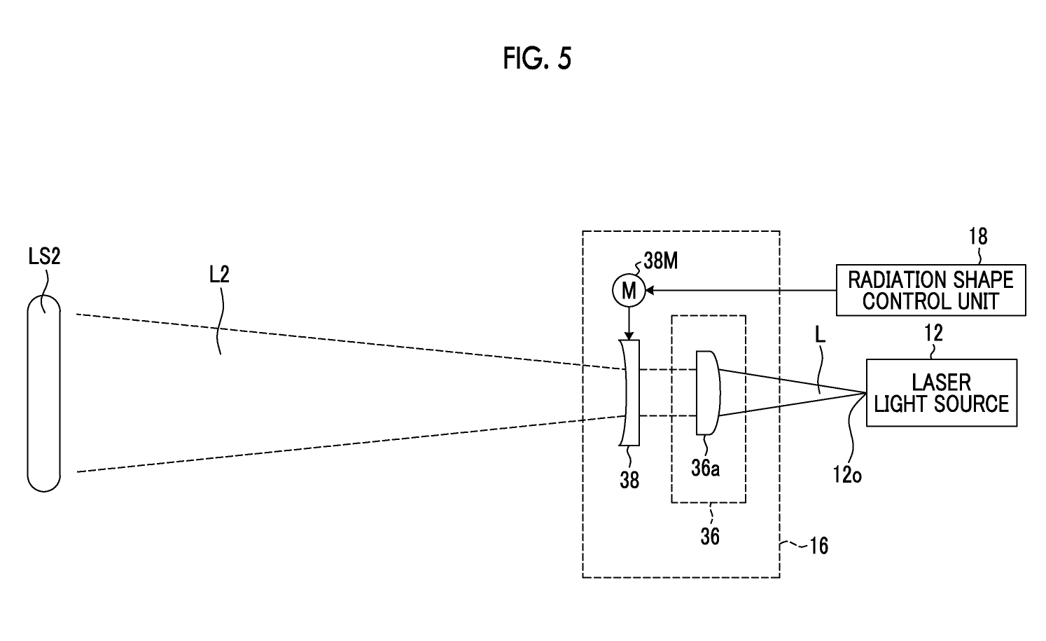

FIG. 1 is a schematic configuration diagram when a laser radar device 10 according to a first embodiment of the present invention forms laser light L into a first radiation shape LS1 (see FIG. 4) and performs light irradiation. FIG. 2 is a schematic configuration diagram when the laser radar device 10 according to the first embodiment of the present invention forms the laser light L into a second radiation shape LS2 (see FIG. 5) and performs light irradiation. The laser radar device 10 shown in FIGS. 1 and 2 can perform laser irradiation on a predetermined measurement-target area A set in advance in two modes of performing laser irradiation in different shapes and scanning methods, and generate three-dimensional information of the measurement-target area A.

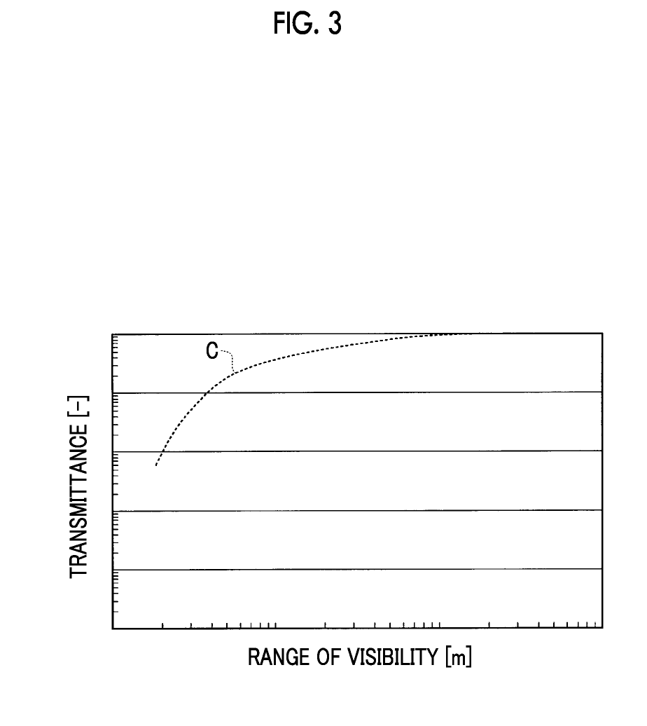

FIG. 3 is a graph illustrating a relationship between the range of visibility of laser light in its radiation direction (hereinafter, simply called the range of visibility) and the transmittance of the laser light L in its radiation direction (hereinafter, simply called transmittance). In the graph of FIG. 3, the horizontal axis represents the range of visibility taken in a logarithmic scale, and the vertical axis represents transmittance taken in a logarithmic scale. A curved line C shown in FIG. 3 indicates a correlation curve between the range of visibility and the transmittance.

As shown in FIG. 3, the transmittance becomes smaller concomitant with a decrease in the range of visibility, and becomes larger concomitant with an increase in the range of visibility. That is, for example, in a case where the laser radar device 10 is used in an outdoor wide space, the range of visibility changes in accordance with changes in the outdoor environment, and the transmittance changes in accordance with this change in the range of visibility. Consequently, the laser radar device 10 properly uses first laser light L1 with which the laser light L is formed into the first radiation shape LS1 and the second radiation shape LS2 with which the laser light L is formed into the second radiation shape LS2, in accordance with the transmittance, that is, in accordance with the range of visibility in the outdoor environment, and thus makes it possible to detect an obstacle while limiting the power consumption of the device even in a case where the transmittance and the range of visibility change concomitant with changes in the outdoor environment. More specifically, the laser radar device 10 changes the radiation shape of the laser light L to the first radiation shape LS1 having a small radiation surface area and a strong radiation intensity per unit area in a case where the range of visibility is smaller than a predetermined threshold value, and changes the radiation shape of the laser light L to the second radiation shape LS2 having a large radiation surface area and a weak radiation intensity per unit area in a case where the range of visibility is larger than the predetermined threshold value. The second radiation shape LS2 has a larger radiation surface area than that of the first radiation shape LS1. That is, the area of the cross-section of the second laser light L2 or the first laser light L1 perpendicular to its radiation direction is large.

In the present embodiment, the laser radar device 10 changes the first radiation shape LS1 to a dot shape taken by the cross-section of a beam of the first laser light L1 perpendicular to its radiation direction, that is, a circular shape having a minute size, changes the second radiation shape LS2 to a line shape, extending in a horizontal direction (first direction) X of the measurement-target area A, taken by the cross-section of a beam of the second laser light L2 perpendicular to its radiation direction, performs scanning in the horizontal direction X of the measurement-target area A and a vertical direction (second direction) Y orthogonal to this horizontal direction X in accordance with the first radiation shape LS1, and performs scanning in the vertical direction Y in accordance with the second radiation shape LS2. In this manner, in a case where the radiation shape of the laser light L is changed to the first radiation shape LS1, it is possible to maximize the intensity of the beam of the laser light L. In addition, in a case where the radiation shape of the laser light L is changed to the second radiation shape LS2, the radiation shape has a larger radiation surface area than that of the first radiation shape LS1. Thereby, a three-dimensional measurement rate for the measurement-target area A is improved, and thus it is possible to measure the measurement-target area A in a short period of time. In addition, in a case where the radiation shape of the laser light L is changed to the second radiation shape LS2, as described later, the first direction and the second direction can be separately acquired from a light reception unit and a radiation scanner 20, respectively, with respect to position information of the laser light L included in second reflected light R2 to be received, and thus it is possible to measure the measurement-target area A with a high level of accuracy. The first radiation shape LS1, the second radiation shape LS2, and scanning performed in accordance with these radiation shapes are not limited to the above. For example, the first radiation shape LS1 may be changed to a line shape extending in the horizontal direction X, the second radiation shape LS2 may be changed to a surface shape extending in the horizontal direction X and the vertical direction Y, scanning in the vertical direction Y of the measurement-target area A may be performed in accordance with the first radiation shape LS1, and scanning may not be performed in accordance with the second radiation shape LS2. In addition, for example, the first radiation shape LS1 or the second radiation shape LS2 may be changed to a line shape extending in the horizontal direction X to half the length or less of the measurement-target area A, and scanning in the horizontal direction X and the vertical direction Y of the measurement-target area A may be performed in accordance with the first radiation shape LS1 or the second radiation shape LS2.

The laser radar device 10 scans and irradiates the measurement-target area A in the horizontal direction X and the vertical direction Y with the first laser light L1 formed into a dot shape which is the first radiation shape LS1, and scans and irradiates the measurement-target area A in the vertical direction Y with the second laser light L2 formed into a line shape extending in the horizontal direction X which is the second radiation shape LS2. The measurement-target area A is an area which is set at a position away by a predetermined distance from the laser radar device 10.

As shown in FIGS. 1 and 2, the laser radar device 10 includes a laser light source 12, a light source control unit 14, a light-transmission-side optical system 16, a radiation shape control unit 18, a radiation scanner 20, a scanner control unit 22, a light-reception-side optical system 24, a light receiving element 26, an amplifier circuit 28, a distance calculation unit 30, and an information generation unit 32. A light reception unit of the present embodiment includes a light receiving element 26 and an amplifier circuit 28. The laser radar device 10 has an external device 34 connected to the information generation unit 32 in a wired or wireless manner. In the present embodiment, an example of the external device 34 includes a computer or the like mounted onto a traveling body.

The laser radar device 10 includes a storage unit and a processing unit. The storage unit includes storage devices such as, for example, a RAM, a ROM and a flash memory, and stores a software program processed by the processing unit, data made reference to by this software program, and the like. In addition, the storage unit also functions as a storage area in which the processing unit temporarily stores processing results or the like. The processing unit reads out and processes a software program or the like from the storage unit, to thereby exhibit a function according to the contents of the software program. Specifically, the processing unit functions as the light source control unit 14, the radiation shape control unit 18, the scanner control unit 22, the distance calculation unit 30 and the information generation unit 32. The light source control unit 14, the radiation shape control unit 18, the scanner control unit 22, the distance calculation unit 30 and the information generation unit 32 generate and output three-dimensional information of the measurement-target area A.

The laser light source 12 emits, that is, oscillates and radiates the beam of the laser light L from a radiation port 12o (see FIGS. 4 and 5) toward the light-transmission-side optical system 16. It is preferable that the laser light source 12 emits the laser light L having, for example, a wavelength of 200 to 2,000 nm. Particularly, in a case where the laser radar device 10 is used in, for example, an outdoor wide space, the laser light source 12 emits the laser light L having a wavelength of 800 to 2,000 nm, thereby allowing stabilized measurement to be realized. The laser light source 12 is constituted by, for example, a laser diode or the like, and emits the laser light L in a pulsed manner on the basis of a light emission command of the light source control unit 14.

The light source control unit 14 controls an operation of the laser light source 12. The light source control unit 14 transmits information of the emission intensity of the laser light L to the radiation shape control unit 18. In addition, the light source control unit 14 has a master clock of the laser radar device 10, and transmits a pulsed emission synchronizing signal to the distance calculation unit 30 simultaneously with the emission of the laser light L.

FIG. 4 is a schematic configuration diagram when the light-transmission-side optical system 16 forms the laser light L into the first radiation shape LS1. FIG. 5 is a schematic configuration diagram when the light-transmission-side optical system 16 forms the laser light L into the second radiation shape LS2. As shown in FIGS. 4 and 5, the light-transmission-side optical system 16 forms the laser light L which is emitted from the radiation port 12o of the laser light source 12 so that its radiation shape is changed to the first radiation shape LS1 or the second radiation shape LS2, to thereby form the first laser light L1 or the second laser light L2. It is preferable that the light-transmission-side optical system 16 includes a basic optical system 36 that forms the radiation shape of the laser light L into the first radiation shape LS1 or the second radiation shape LS2 and an insertion-extraction optical element 38 that switches the radiation shape of the laser light L between the first radiation shape LS1 and the second radiation shape LS2 by being inserted or extracted into or from an optical path of the laser light L. In this case, the light-transmission-side optical system 16 can switch the radiation shape of the laser light L simply and reliably. More specifically, as in the present embodiment, it is preferable that the light-transmission-side optical system 16 includes the basic optical system 36 that forms the radiation shape of the laser light L into the first radiation shape LS1 having a small radiation surface area, and the insertion-extraction optical element 38 that switches the radiation shape of the laser light L to the second radiation shape LS2 having a large radiation surface area by being inserted into the optical path of the laser light L to move to its insertion position, that is, by entering a state of being disposed in the optical path of the laser light L. In this case, the light-transmission-side optical system 16 can switch the radiation shape of the laser light L again to the first radiation shape LS1 having a small radiation surface area by the insertion-extraction optical element 38 being extracted from the optical path of the laser light L to move from its insertion position to its extraction position, that is, by entering a state of not being disposed in the optical path of the laser light L. In addition, the light-transmission-side optical system 16 can switch the radiation shape of the laser light L more simply and reliably. In addition, the light-transmission-side optical system 16 makes it possible to appropriately select the second radiation shape LS2 by selecting the insertion-extraction optical element 38.

In the present embodiment, the basic optical system 36 includes an optical element 36a provided so as to be fixed onto the optical path of the laser light L. In the present embodiment, the basic optical system 36 is a single optical element 36a, but may have a plurality of optical elements combined with each other without being limited thereto. The optical element 36a is constituted by, for example, a one-sided convex lens in which the incidence-side curved surface of the laser light L is convex, and the emission-side curved surface of the first laser light L1 formed into the first radiation shape LS1 is planar. It is preferable that the optical element 36a is a collimator lens on which aberration correction is performed so as to be able to obtain parallel light. In this case, it is possible to reduce the formation of an incomplete image without a beam of reflected light R of the laser light L being correctly converged on one point in the light reception unit.

In the present embodiment, the insertion-extraction optical element 38 is an element that diffuses the beam of the laser light L. The insertion-extraction optical element 38 diffuses the beam of the first laser light L1 formed into the first radiation shape LS1 by the basic optical system 36 in a line shape extending in the horizontal direction X, to thereby switch the radiation shape of the first laser light L1 from the first radiation shape LS1 to the second radiation shape LS2. In the present embodiment, the insertion-extraction optical element 38 is a single optical element, but may have a plurality of optical elements combined with each other without being limited thereto. The insertion-extraction optical element 38 makes it possible to appropriately select the second radiation shape LS2 by selecting the shape and configuration thereof. The insertion-extraction optical element 38 is constituted by, for example, a cylindrical concave lens in which the incidence-side curved surface of the first laser light L1 is planar, and the emission-side curved surface of the second laser light L2 formed into the second radiation shape LS2 is concave.

The insertion-extraction optical element 38 has a drive motor 38M connected thereto which drives the insertion-extraction optical element 38 between its insertion position and its extraction position. The drive motor 38M is connected to the radiation shape control unit 18, and moves the insertion-extraction optical element 38 to its insertion position on the basis of an insertion command which is transmitted from the radiation shape control unit 18. In addition, the drive motor 38M moves the insertion-extraction optical element 38 to its extraction position on the basis of an extraction command which is transmitted from the radiation shape control unit 18. That is, the light-transmission-side optical system 16 causes the drive motor 38M to move the insertion-extraction optical element 38 on the basis of the insertion command and the extraction command which are transmitted from the radiation shape control unit 18, to thereby switch a radiation shape for forming the beam of the laser light L between the first radiation shape LS1 and the second radiation shape LS2.

The radiation shape control unit 18 controls the light-transmission-side optical system 16, to thereby control the radiation shape for forming the laser light L into the first radiation shape LS1 or the second radiation shape LS2. The radiation shape control unit 18 acquires information of the emission intensity of the laser light L from the light source control unit 14. In addition, the radiation shape control unit 18 acquires information of the intensity of a received signal from the amplifier circuit 28. The radiation shape control unit 18 measures the range of visibility on the basis of the information of the emission intensity of the laser light L acquired from the light source control unit 14 and the information of the intensity of the received signal acquired from the amplifier circuit 28. Thereby, the radiation shape control unit 18 makes it possible to measure the range of visibility according to the capability of the laser radar device 10. The radiation shape control unit 18 determines whether the measured range of visibility is equal to or greater than a threshold value, or is less than the threshold value. In addition, the radiation shape control unit 18 determines whether the measured range of visibility is set to be equal to or greater than the threshold value, or is set to be less than the threshold value. Thereby, the radiation shape control unit 18 makes it possible to determine the range of visibility according to the capability of the laser radar device 10.

Meanwhile, the radiation shape control unit 18 may not acquire the information of the emission intensity of the laser light L from the light source control unit 14, or acquire the information of the intensity of the received signal from the amplifier circuit 28. In this case, the radiation shape control unit 18 receives information of the range of visibility which is measured and output by a visibility meter as a surrounding environment detection unit, further provided in the laser radar device 10, from this visibility meter, instead of measuring the range of visibility on the basis of the information of the emission intensity of the laser light L from the light source control unit 14 and the information of the intensity of the received signal from the amplifier circuit 28, and determines whether this range of visibility is equal to or greater than the threshold value or less than the threshold value, or whether this range of visibility is set to be equal to or greater than the threshold value or set to be less than the threshold value. Thereby, the radiation shape control unit 18 can measure an objective range of visibility using the visibility meter even under a situation such as during uprise of the device, and thus makes it possible to determine the objective range of visibility.

In a case where it is determined that the measured range of visibility is equal to or greater than the threshold value, the radiation shape control unit 18 performs control so that the light-transmission-side optical system 16 forms the radiation shape of the laser light L into the second radiation shape LS2. Specifically, in a case where the range of visibility is equal to or greater than the threshold value, and the insertion-extraction optical element 38 is located at its insertion position, the radiation shape control unit 18 holds the element as it is without issuing a command to the drive motor 38M. On the other hand, in a case where the range of visibility is equal to or greater than the threshold value, and the insertion-extraction optical element 38 is located at its extraction position, the radiation shape control unit 18 transmits the insertion command to the drive motor 38M, to thereby move the insertion-extraction optical element 38 to its insertion position and switch a radiation shape for forming the beam of the laser light L from the first radiation shape LS1 to the second radiation shape LS2. The radiation shape control unit 18 transmits second shape information, which is information for controlling the radiation shape into the second radiation shape LS2, to the scanner control unit 22.

In a case where it is determined that the range of visibility is less than the threshold value, the radiation shape control unit 18 performs control so that the light-transmission-side optical system 16 forms the radiation shape of the laser light L into the first radiation shape LS1. Specifically, in a case where the range of visibility is less than the threshold value, and the insertion-extraction optical element 38 is located at its extraction position, the radiation shape control unit 18 holds the element as it is without issuing a command to the drive motor 38M. On the other hand, in a case where the range of visibility is less than the threshold value, and the insertion-extraction optical element 38 is located at its insertion position, the radiation shape control unit 18 transmits the extraction command to the drive motor 38M, to thereby move the insertion-extraction optical element 38 to its extraction position and switch a radiation shape for forming the beam of the laser light L from the second radiation shape LS2 to the first radiation shape LS1. The radiation shape control unit 18 transmits first shape information, which is information for controlling the radiation shape into the first radiation shape LS1, to the scanner control unit 22.

The radiation shape control unit 18 determines whether the range of visibility is equal to or greater than the threshold value or less than the threshold value, for each constant time or consecutively. That is, the radiation shape control unit 18 can determine that the range of visibility is set to be equal to or greater than the threshold value from less than the threshold value, and can determine that the range of visibility is set to be less than the threshold value from equal to or greater than the threshold value. In a case where it is determined that range of visibility is set to be equal to or greater than the threshold value from less than the threshold value, the radiation shape control unit 18 transmits the insertion command to the drive motor 38M, to thereby move the insertion-extraction optical element 38 to its insertion position and switch a radiation shape for forming the beam of the laser light L from the first radiation shape LS1 to the second radiation shape LS2. The radiation shape control unit 18 transmits the second shape information, which is information equivalent to information for switching the radiation shape to the second radiation shape LS2, to the scanner control unit 22. In a case where it is determined that the range of visibility is set to be less than the threshold value from equal to or greater than the threshold value, the radiation shape control unit 18 transmits the extraction command to the drive motor 38M, to thereby move the insertion-extraction optical element 38 to its extraction position and switch a radiation shape for forming the beam of the laser light L from the second radiation shape LS2 to the first radiation shape LS1. The radiation shape control unit 18 transmits the first shape information, which is information equivalent to information for switching the radiation shape to the first radiation shape LS1, to the scanner control unit 22.

In a case where the peak value of the intensity of the received signal is set to be equal to or greater than a predetermined first threshold value, the radiation shape control unit 18 determines that the measured range of visibility is set to be equal to or greater than the threshold value, and preferably performs control so that the light-transmission-side optical system 16 forms the radiation shape of the laser light L into the second radiation shape LS2. Since the peak value of the intensity of the received signal has the best sensitivity among the intensities of the received signal in a case where the range of visibility is large, the radiation shape control unit 18 can appropriately determine that the range of visibility is set to be equal to or greater than the threshold value on the basis of the peak value of the intensity of the received signal having a good sensitivity, and can control the radiation shape of the laser light L into the second radiation shape LS2.

In a case where the intensity of the received signal at a predetermined position of the end portion of the light reception unit, that is, a predetermined position of the end portion of the light receiving element 26 is set to be less than a predetermined second threshold value, the radiation shape control unit 18 determines that the measured range of visibility is set to be less than the threshold value, and preferably performs control so that the light-transmission-side optical system 16 forms the radiation shape of the laser light L into the second radiation shape LS2. Since the received signal is not able to be gradually detected from the end portion of the light reception unit in the range of visibility is small, the radiation shape control unit 18 can appropriately determine the range of visibility is set to be less than the threshold value on the basis of whether or not to detect the received signal, and can control the radiation shape of the laser light L into the first radiation shape LS1.

Meanwhile, the laser radar device 10 according to the first embodiment is configured such that the first threshold value is used in a case where it is determined that the range of visibility is set to be equal to or greater than the threshold value from less than the threshold value, the second threshold value is used in a case where it is determined that the range of visibility is set to be less than the threshold value from equal to or greater than the threshold value, and that two threshold values, that is, the first threshold value and the second threshold value are provided so that hysteresis remains when the radiation shape of the laser light L is switched. However, without being limited thereto, using one threshold value, it is determined that the range of visibility is set to be equal to or greater than the threshold value from less than the threshold value, and it is determined that the range of visibility is set to be less than the threshold value from equal to or greater than the threshold value, whereby the radiation shape of the laser light L may be switched so that hysteresis does not remain. In addition, in the laser radar device 10 according to the first embodiment, the radiation shape of the laser light L is switched in a state where the range of visibility is less than the threshold value and a state where the range of visibility is equal to or greater than the threshold value. However, substantially, the radiation shape of the laser light L may also be switched in a state where the range of visibility is larger than the threshold value and a state where the range of visibility is equal to or less than the threshold value.

The radiation scanner 20 causes the laser light L formed in the light-transmission-side optical system 16 to scan and irradiate the measurement-target area A in accordance with a radiation shape. The radiation scanner 20 causes the first laser light L1 of which the radiation shape is formed into a dot shape as the first radiation shape LS1 to scan the measurement-target area A in the horizontal direction X and the vertical direction Y. In addition, the radiation scanner 20 causes the second laser light L2 of which the radiation shape is formed into a line shape as the second radiation shape LS2 extending in the horizontal direction X to scan the measurement-target area A in the vertical direction Y.

As shown in FIGS. 1 and 2, the radiation scanner 20 has a function of scanning the measurement-target area A two-dimensionally, and includes a horizontal scanning portion 42 that performs scanning with the first laser light L1 in the horizontal direction X and a vertical scanning portion 44 that performs scanning with the first laser light L1 or the second laser light L2 in the vertical direction Y. The horizontal scanning portion 42 and the vertical scanning portion 44 are constituted by, for example, a galvano scanner, and include galvano mirrors 42a and 44a which are planar mirrors and drive motors 42b and 44b that tremble the mirror surfaces of the galvano mirrors 42a and 44a.

In a case where the light-transmission-side optical system 16 forms the radiation shape of the laser light L into the first radiation shape LS1, the horizontal scanning portion 42 drives the drive motor 42b to tremble the galvano mirror 42a under the control of the scanner control unit 22. Thereby, the first laser light L1 formed into the first radiation shape LS1 by the light-transmission-side optical system 16 has its horizontal angle changed by the galvano mirror 42a, and is scanned in the horizontal direction X of the measurement-target area A. In a case where the light-transmission-side optical system 16 forms the radiation shape of the laser light L into the second radiation shape LS2, the horizontal scanning portion 42 stops driving the drive motor 42b to fix the galvano mirror 42a at a predetermined angle under the control of the scanner control unit 22. Thereby, the second laser light L2 formed into the second radiation shape LS2 by the light-transmission-side optical system 16 has its horizontal angle fixed by the galvano mirror 42a.

Even in a case where the light-transmission-side optical system 16 forms the radiation shape of the laser light L into the first radiation shape LS1, and even in a case where the light-transmission-side optical system 16 forms the radiation shape of the laser light L into the second radiation shape LS2, the vertical scanning portion 44 drives the drive motor 44b to tremble the galvano mirror 44a under the control of the scanner control unit 22. Thereby, the first laser light L1 or the second laser light L2 reflected from the galvano mirror 42a has its vertical angle changed by the galvano mirror 44a, and is scanned in the vertical direction Y of the measurement-target area A. Meanwhile, in the present embodiment, as an example of the horizontal scanning portion 42 and the vertical scanning portion 44, a configuration in which the Galvano scanner is used has been described, but a polygon scanner having, for example, a polygon mirror may be used without being limited to such a configuration.

The scanner control unit 22 controls the operation of the radiation scanner 20. Specifically, the scanner control unit 22 receives the first shape information or the second shape information which are transmitted from the radiation shape control unit 18, determines a scanning pattern on the basis of the first shape information or the second shape information which are received, and performs scanning on the basis of the determined scanning pattern. The scanner control unit 22 determines to perform scanning with the scanning pattern in the horizontal direction X and the vertical direction Y in a case where the first shape information is received from the radiation shape control unit 18, and determines to perform scanning with the scanning pattern in the vertical direction Y in a case where the second shape information is received from the radiation shape control unit 18. In a case where scanning in the horizontal direction X and the vertical direction Y is performed and a case where scanning in the vertical direction Y is performed, the scanner control unit 22 controls the operations of the drive motors 42b and 44b on the basis of a predetermined scanning pattern.

Thereby, the radiation scanner 20 controlled by the scanner control unit 22 irradiates the measurement-target area A by causing the first laser light L1 formed into the first radiation shape LS1 to scan based on the scanning pattern, and points (regions) within this irradiated measurement-target area A become first measurement points S1 sequentially. In this case, the scanner control unit 22 acquires information of the mirror angles (light transmission control angles) of the galvano mirrors 42a and 44a corresponding to each of the first measurement points S1, and transmits these mirror angles to the information generation unit 32. In addition, the radiation scanner 20 controlled by the scanner control unit 22 irradiates the measurement-target area A by causing the second laser light L2 formed into the second radiation shape LS2 to scan based on the scanning pattern, and points (regions) within this irradiated measurement-target area A become second measurement points S2 sequentially. In this case, the scanner control unit 22 acquires information of the mirror angle (light transmission control angle) of the galvano mirror 44a corresponding to each of the second measurement points S2, and transmits the mirror angle to the information generation unit 32. Here, the information of the mirror angle (light transmission control angle) of the galvano mirror 42a is equivalent to position information of each of the first measurement points S1 in the horizontal direction X, and the information of the mirror angle (light transmission control angle) of the galvano mirror 44a is equivalent to position information of each of the first measurement points S1 or each of the second measurement points S2 in the vertical direction Y.

In the present embodiment, the radiation scanner 20 controlled by the scanner control unit 22 scans and irradiates the measurement-target area A with the first laser light L1 formed into the first radiation shape LS1, and thus it is possible to improve signal intensity by increasing the irradiation power density of the first laser light L1 with which the measurement-target area A is irradiated. Thereby, it is possible to secure measurement performance even under the environmental conditions in which the transmittance of the first laser light L1 is low, for example, a fog environment or a rain environment. In addition, in the present embodiment, the radiation scanner controlled by the scanner control unit 22 scans and irradiates the measurement-target area A with the second laser light L2 formed into the second radiation shape LS2 in a direction perpendicular to the extending direction of the second radiation shape LS2, and thus it is possible to improve the three-dimensional measurement rate of the measurement-target area A, and to measure the measurement-target area A in a short period of time.

The light-reception-side optical system 24 receives first reflected light R1 reflected from each of the first measurement points S1 in the measurement-target area A or second reflected light R2 reflected from each of the second measurement points S2 in the measurement-target area A, and condenses the two beams of light in the vertical direction Y.

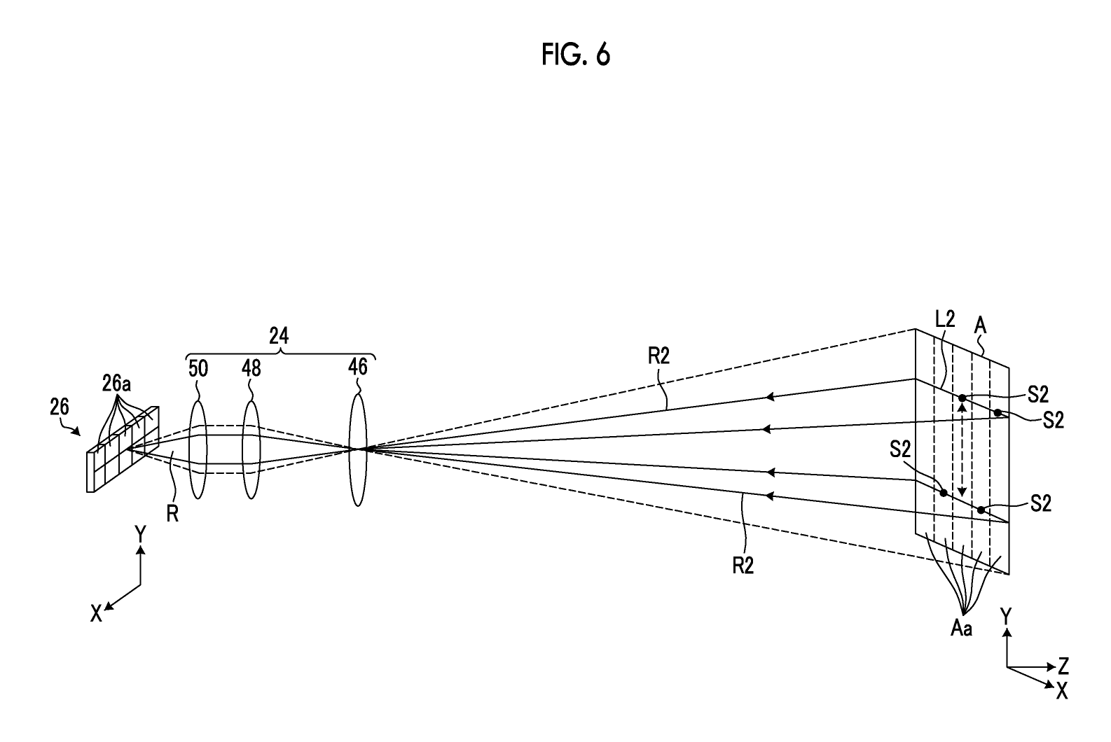

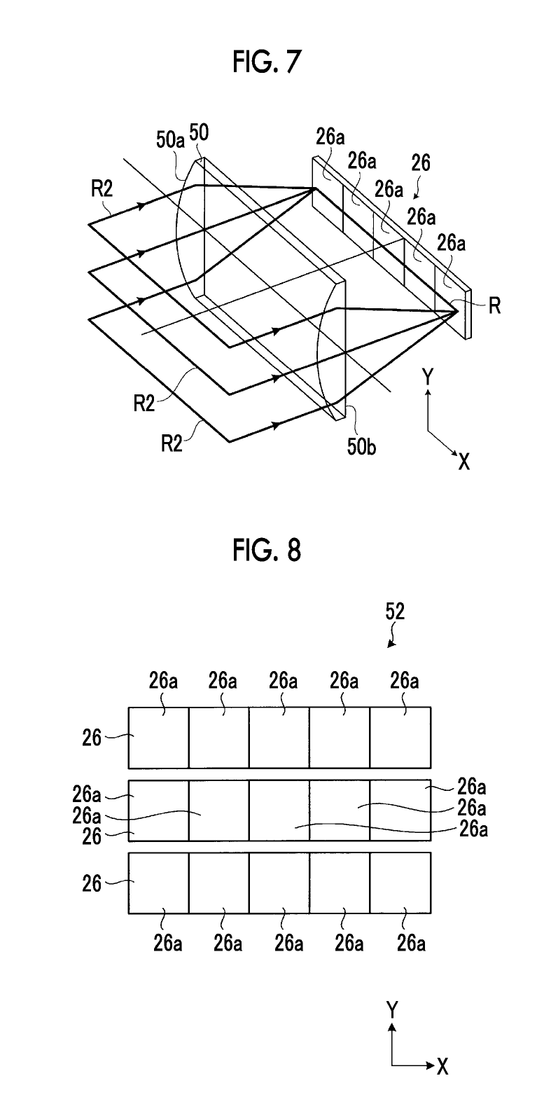

FIG. 6 is a schematic diagram illustrating an example of a peripheral configuration including the light-reception-side optical system 24 and the light receiving element 26. FIG. 7 is a perspective view illustrating an example of a peripheral configuration including the light-reception-side optical system 24 and the light receiving element 26. As shown in FIG. 6, the light-reception-side optical system 24 includes a light-reception-side lens 46, a relay lens 48, and a condensing lens 50. In FIG. 6, the light-reception-side optical system 24 is configured to be provided with one relay lens 48 and one condensing lens 50, but a lens unit may be, of course, used in which a plurality of respective lenses are combined.

The light-reception-side lens 46 receives the first reflected light R1 or the second reflected light R2 which is reflected from each of the first measurement points S1 or each of the second measurement points S2 in the measurement-target area A, and forms an image of each of the first measurement points S1 or each of the second measurement points S2 at a predetermined position (imaging position) on the downstream side of the light-reception-side lens 46. Meanwhile, in FIGS. 5 and 6, a case is shown in which the second reflected light R2 reflected from each of the second measurement points S2 is received, and an image of each of the second measurement points S2 is formed, but the same is true of a case in which the first reflected light R1 reflected from each of the first measurement points S1 is received, and an image of each of the first measurement points S1 is formed.

The relay lens 48 is a lens, disposed at the imaging position of the light-reception-side lens 46, which substantially collimates a subsequent flux of light in a state where imaging information of the light-reception-side lens 46 at the imaging position is held, and transmits this imaging information, as it it, to the condensing lens 50. The relay lens 48 is constituted by, for example, a convex lens. In the present embodiment, the relay lens 48 is configured to be disposed at the imaging position of the light-reception-side lens 46, but may be disposed near the imaging position of the light-reception-side lens 46 or behind the imaging position, without being limited thereto.

The condensing lens 50 is disposed on the downstream side of the relay lens 48, and is constituted by, for example, a cylindrical convex lens in which the incidence side of the first reflected light R1 or the second reflected light R2 has a curved surface 50a and the emission side thereof has a planar surface 50b, as shown in FIG. 7. This condensing lens 50 is formed so that a light-condensing rate in the vertical direction Y becomes larger than a light-condensing rate in the horizontal direction X. That is, the condensing lens 50 condenses the parallel flux of light of the first reflected light R1 or the second reflected light R2 transmitted from the relay lens 48, that is, all the pieces of imaging information in the vertical direction Y toward the light receiving element 26 which is a line sensor extending in the horizontal direction X. Therefore, the light-reception-side optical system 24 can form an image in the light-reception-side lens 46 with a simple configuration in which three types of lenses are combined, and condense the imaging information in the light receiving element 26 using the relay lens 48 and the condensing lens 50, whereby it is possible to realize scanlessness on the light reception side. Meanwhile, hereinafter, the first reflected light R1 or the second reflected light R2 condensed toward the light receiving element 26 by the light-reception-side optical system 24 is called reflected light R appropriately collectively.

The light receiving element 26 constitutes a light reception unit of the present embodiment, together with the amplifier circuit 28. In the light reception unit, it is preferable that the light receiving element 26 includes a light reception region of the reflected light R condensed by the light-reception-side optical system 24. In this case, the light receiving element 26 of the light reception unit can receive the reflected light R of the entirety of the measurement-target area A without performing scanning on the light reception side regardless of the radiation shape of the laser light L, and thus it is possible to realize scanlessness on the light reception side, which leads to a simplified configuration.

In the present embodiment, the light receiving element 26 is a line sensor configured to include a plurality of (five in the present embodiment) light reception cells 26a lined up along the horizontal direction X. Each of the light reception cells 26a is formed of a photoelectric conversion element (for example, photodiode) that receives the reflected light R and converts the received light into a current, and is formed of a single element having a single pixel. Therefore, it is possible to respond to the first laser light L1 or the second laser light L2 having a short pulse.

In this configuration, the measurement-target area A is divided into five division areas Aa in accordance with five which is the number of light reception cells 26a. The reflected light R from the measurement-target area A is spatially resolved into five parts corresponding to the division areas Aa, and is received in a light reception cell 26a corresponding to a division area Aa. In this case, the reflected light R from the division area Aa is condensed by the condensing lens 50 in the vertical direction Y, and is received in a corresponding light reception cell 26a. Therefore, the parallel flux of light of the reflected light R from the measurement-target area A, that is, all the pieces of imaging information are condensed in the light receiving element 26.

The light receiving element 26 receives the reflected light R condensed in the light-reception-side optical system 24, and outputs a received signal based on the first laser light L1 or the second laser light L2 included in the received reflected light R. The amplifier circuit 28 amplifies the received signal which is output by the light receiving element 26 as a voltage signal. Since the received signal which is output by the light receiving element 26 is a weak current signal, the amplifier circuit 28 converts the current signal into a voltage signal to output the converted signal to the distance calculation unit 30.

The distance calculation unit 30 calculates distance information of each of the first measurement points S1 or each of the second measurement points S2 in the measurement-target area A, on the basis of the received signal amplified by the amplifier circuit 28. The distance calculation unit acquires the pulsed emission synchronizing signal transmitted from the light source control unit 14 and the received signal transmitted from the amplifier circuit 28, calculates a distance to each of the first measurement points S1 or each of the second measurement points S2 in the measurement-target area A irradiated with the first laser light L1 or the second laser light L2, and transmits the distance information to the information generation unit 32. Specifically, the distance calculation unit 30 measures a time which will be taken until the first laser light L1 or the second laser light L2 is emitted and then the reflected light R is received on the basis of the emission synchronizing signal and the received signal, and calculates a distance to each of the first measurement points S1 or each of the second measurement points S2 at which the first laser light L1 or the second laser light L2 is reflected on the basis of this measurement time. In addition, the distance calculation unit 30 may transmit light reception intensity included in the received signal, together with the distance information, to the information generation unit 32 in association with the distance information.

In addition, the distance calculation unit 30 calculates position information in the horizontal direction X of each of the first measurement points S1 or each of the second measurement points S2 in the measurement-target area A, on the basis of the received signal amplified by the amplifier circuit 28. Specifically, the distance calculation unit 30 acquires pixel information (number) of a light reception cell 26a in which the reflected light R is received, calculates position information in the horizontal direction X of each of the first measurement points S1 or each of the second measurement points S2 from this pixel information, and transmits this position information to the information generation unit 32.

Meanwhile, in a case where the light-transmission-side optical system 16 forms the radiation shape of the laser light L into the first radiation shape LS1, the distance calculation unit 30 calculates position information in the horizontal direction X of each of the first measurement points S1 in the measurement-target area A on the basis of the received signal amplified by the amplifier circuit 28, and may not transmit this position information to the information generation unit 32. In this case, the information generation unit 32 uses the position information in the horizontal direction X of each of the first measurement points S1 in the measurement-target area A which is calculated on the basis of the information of the mirror angle (light transmission control angle) of the galvano mirror 42a corresponding to each of the first measurement points S1 transmitted from the scanner control unit 22, instead of the position information in the horizontal direction X of each of the first measurement points S1 transmitted from the distance calculation unit 30.

The information generation unit 32 receives the information of the mirror angle (light transmission control angle) of the galvano mirror 44a corresponding to each of the first measurement points S1 or each of the second measurement points S2 which is transmitted from the scanner control unit 22, and calculates position information in the vertical direction Y of each of the first measurement points S1 or each of the second measurement points S2 in the measurement-target area A, on the basis of this information of the mirror angle. The information generation unit 32 receives the position information in the horizontal direction X of each of the first measurement points S1 or each of the second measurement points S2 in the measurement-target area A which is transmitted from the distance calculation unit 30. The information generation unit 32 acquires coordinate information at each of the first measurement points S1 or each of the second measurement points S2 on the basis of the position information in the vertical direction Y of each of the first measurement points S1 or each of the second measurement points S2 calculated on the basis of the information of the mirror angle, and the position information in the horizontal direction X of each of the first measurement points S1 or each of the second measurement points S2 received from the distance calculation unit 30, and generates three-dimensional information of the measurement-target area A from the distribution of the coordinate information of a plurality of first measurement points S1 or second measurement points S2 present in the measurement-target area A. In this configuration, since the spatial position coordinate acquisition of the received signal based on light-reception-side visual field scanning is not required, it is possible to reduce a load of signal processing for generating the three-dimensional information. The three-dimensional information of the measurement-target area A generated by the information generation unit 32 is transmitted to the external device 34 (such as, for example, a computer mounted in a traveling body) in a wired or wireless manner, and is used in this external device 34.

Meanwhile, in a case where the light-transmission-side optical system 16 forms the radiation shape of the laser light L into the first radiation shape LS1, the information generation unit 32 may use the position information in the horizontal direction X of each of the first measurement points S1 in the measurement-target area A which is calculated on the basis of the information of the mirror angle (light transmission control angle) of the galvano mirror 42a corresponding to each of the first measurement points S1 transmitted from the scanner control unit 22, instead of receiving the position information in the horizontal direction X of each of the first measurement points S1 from the distance calculation unit 30. In this case, the information generation unit 32 acquires coordinate information at each of the first measurement points S1 on the basis of the position information in the horizontal direction X and the vertical direction Y of each of the first measurement points S1 calculated on the basis of the information of the mirror angle, and generates three-dimensional information of the measurement-target area A from the distribution of the coordinate information of a plurality of first measurement points S1 present in the measurement-target area A.

Next, a modification example of the light receiving element 26 will be described. FIG. 8 is a diagram illustrating a modification example of the light receiving element 26. In the above-described embodiment, the light receiving element 26 is configured to be provided with one line sensor that has the light reception cell 26a disposed side by side in the horizontal direction X. However, as shown in FIG. 8, it is also possible to form a line sensor array 52 in which a plurality of (for example, three) line sensors 26 are lined up in an array in the vertical direction Y. In this configuration, the remaining two line sensors 26 lined up in the vertical direction Y are preliminarily disposed, and even in a case of the deviation of a position at which light is condensed in the light receiving element (line sensor 26) by the light-reception-side optical system 24 during the operation of the laser radar device 10, or an increase in light-condensing size due to deviation from an optimum point, it is possible to use a line sensor 26 of the line sensor array 52 in which the reflected light R is condensed. According to this, it is possible to reliably receive the reflected light R in the light receiving element, and to secure the quality of measurement.

In addition, the light receiving element 26 can be appropriately changed in accordance with the first radiation shape LS1 and the second radiation shape LS2. For example, in a case where the second radiation shape LS2 is formed into a surface shape extending in the horizontal direction X and the vertical direction Y, it is preferable that the light receiving element 26 includes a light reception region of the reflected light R condensed by the light-reception-side optical system 24 by lining up the light reception cells 26a in a surface shape. In this case, it is possible to realize scanlessness on the light reception side, which leads to a simplified configuration. On the other hand, in a case where the second radiation shape LS2 is formed into a line shape extending in the horizontal direction X as described above, it is preferable that the light receiving element 26 is formed to be a line sensor or to be the line sensor array 52 in which several rows of line sensors are lined up in the vertical direction Y. In this case, since the number of pixels to be processed is reduced, it is possible to reduce a burden on the processing unit, and to measure a useful measurement-target area A.

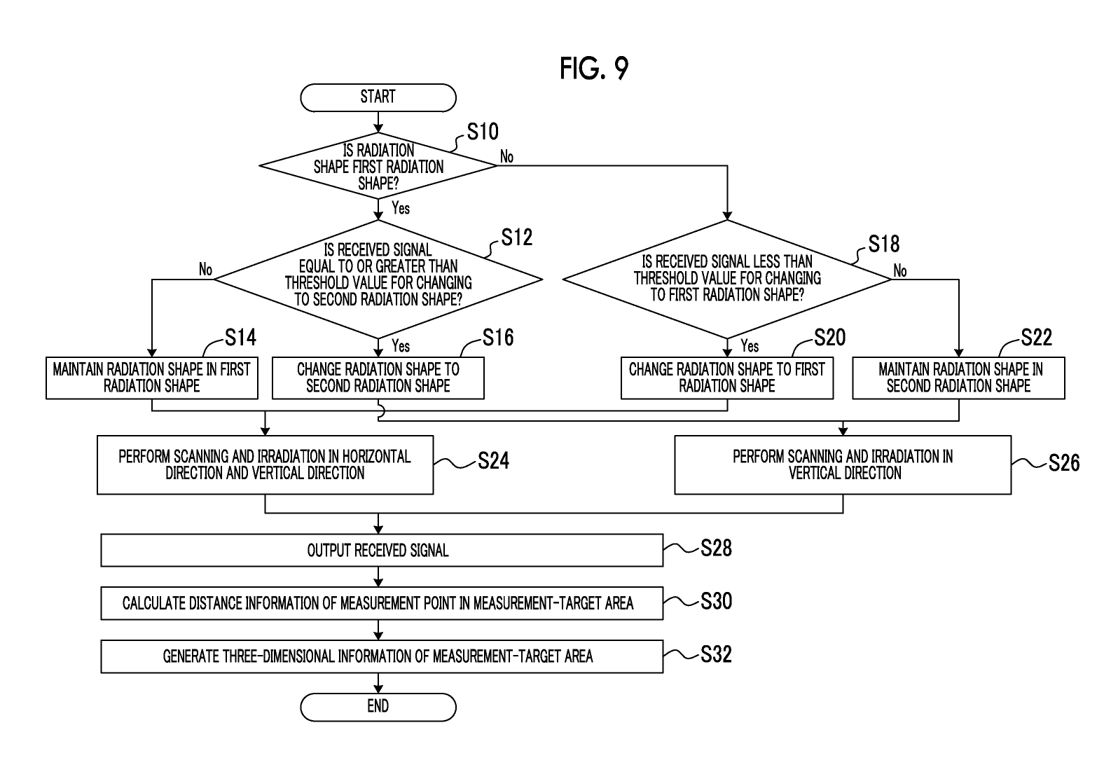

The operation of the laser radar device 10 according to the present embodiment which has such a configuration will be described below. FIG. 9 is a flow diagram of an example of processing of the laser radar device according to the first embodiment of the present invention. A processing method which is executed by the laser radar device 10 will be described with reference to FIG. 9.

First, the radiation shape control unit 18 in the laser radar device 10 determines whether the radiation shape of the laser light L is formed into the first radiation shape LS1 (step S10). The radiation shape control unit 18 then acquires information of the emission intensity of the laser light L from the light source control unit 14, and acquires information of the intensity of the received signal from the amplifier circuit 28.

In a case where the radiation shape of the laser light L is the first radiation shape LS1 (Yes in step S10), the radiation shape control unit 18 determines whether the peak value of the intensity of the received signal acquired from the amplifier circuit 28 is equal to or greater than the predetermined first threshold value (step S12).

In a case where the peak value of the intensity of the received signal acquired from the amplifier circuit 28 is not equal to or greater than the predetermined first threshold value (No in step S12), the radiation shape control unit 18 determines that the measured range of visibility is not set to be equal to or greater than the threshold value, and performs control so that the light-transmission-side optical system 16 maintains the radiation shape of the laser light L into the first radiation shape LS1 (step S14). Specifically, in a case where it is determined that the range of visibility is maintained to be less than the threshold value, the radiation shape control unit 18 holds the insertion-extraction optical element 38 at its extraction position without transmitting a command to the drive motor 38M, and maintains a radiation shape for forming a beam of the laser light L into the first radiation shape LS1. The radiation shape control unit 18 then transmits the first shape information which is information for controlling the radiation shape into the first radiation shape LS1 to the scanner control unit 22, and advances the process to step S24.

In a case where the peak value of the intensity of the received signal acquired from the amplifier circuit 28 is equal to or greater than the predetermined first threshold value (Yes in step S12), the radiation shape control unit 18 determines that the measured range of visibility is set to be equal to or greater than the threshold value, and performs control so that the light-transmission-side optical system 16 switches the radiation shape of the laser light L from the first radiation shape LS1 to the second radiation shape LS2 (step S16). Specifically, in a case where it is determined that the range of visibility is set to be equal to or greater than the threshold value from less than the threshold value, the radiation shape control unit 18 moves the insertion-extraction optical element 38 to its insertion position by transmitting an insertion command to the drive motor 38M, and switches a radiation shape for forming a beam of the laser light L from the first radiation shape LS1 to the second radiation shape LS2. The radiation shape control unit 18 then transmits the second shape information which is information for controlling the radiation shape into the second radiation shape LS2 to the scanner control unit 22, and advances the process to step S26.

In a case where the radiation shape of the laser light L is the second radiation shape LS2 (No in step S10), the radiation shape control unit 18 determines whether the peak value of the intensity of the received signal acquired from the amplifier circuit 28 is less than the predetermined second threshold value (step S18).

In a case where the peak value of the intensity of the received signal acquired from the amplifier circuit 28 is less than the predetermined first threshold value (Yes in step S18), the radiation shape control unit 18 determines that the measured range of visibility is set to be less than the threshold value, and performs control so that the light-transmission-side optical system 16 switches the radiation shape of the laser light L from the second radiation shape LS2 to the first radiation shape LS1 (step S20).

Specifically, in a case where it is determined that the range of visibility is set to be less than the threshold value from equal to or greater than the threshold value, the radiation shape control unit 18 moves the insertion-extraction optical element 38 to its extraction position by transmitting an extraction command to the drive motor 38M, and switches a radiation shape for forming a beam of the laser light L from the second radiation shape LS2 to the first radiation shape LS1. The radiation shape control unit then transmits the first shape information which is information for controlling the radiation shape into the first radiation shape LS1 to the scanner control unit 22, and advances the process to step S24.

In a case where the peak value of the intensity of the received signal acquired from the amplifier circuit 28 is not less than the predetermined second threshold value (No in step S18), the radiation shape control unit 18 determines that the measured range of visibility is not set to be less than the threshold value, and performs control so that the light-transmission-side optical system 16 maintains the radiation shape of the laser light L into the second radiation shape LS2 (step S22). Specifically, in a case where it is determined that the range of visibility is maintained to be equal to or greater than the threshold value, the radiation shape control unit 18 holds the insertion-extraction optical element 38 at its insertion position without transmitting a command to the drive motor 38M, and maintains a radiation shape for forming a beam of the laser light L into the second radiation shape LS2. The radiation shape control unit 18 then transmits the second shape information which is information for controlling the radiation shape into the second radiation shape LS2 to the scanner control unit 22, and advances the process to step S26.

The scanner control unit 22 receives the first shape information transmitted from the radiation shape control unit 18 in step S14 or step S20, and performs control so that the radiation scanner 20 performs scanning and irradiation with the laser light L in accordance with a case where the radiation shape is the first radiation shape LS1 (step S24). Specifically, the scanner control unit 22 determines to perform scanning with a scanning pattern in the horizontal direction X and the vertical direction Y on the basis of the received first shape information, and controls an operation so as to tremble the drive motors 42b and 44b on the basis of the determined scanning pattern, to thereby cause the radiation scanner 20 to perform scanning and irradiation with the first laser light L1 formed into the first radiation shape LS1. The scanner control unit 22 then acquires the mirror angles (light transmission control angles) of the galvano mirrors 42a and 44a corresponding to each of the first measurement points S1 which are points within the irradiated measurement-target area A, and transmits these mirror angles to the information generation unit 32. In this manner, the laser radar device 10 is set to be in a mode for scanning the measurement-target area A with the first laser light L1 of which the radiation shape is formed into the first radiation shape LS1, and receiving the first reflected light R1 from the measurement-target area A, and advances the process to step S28.

The scanner control unit 22 receives the second shape information transmitted from the radiation shape control unit 18 in step S16 or step S22, and performs control so that the radiation scanner 20 performs scanning and irradiation with the laser light L in accordance with a case where the radiation shape is the second radiation shape LS2 (step S26). Specifically, the scanner control unit 22 determines to perform scanning with a scanning pattern in the vertical direction Y on the basis of the received second shape information, and controls an operation so as to tremble the drive motor 44b on the basis of the determined scanning pattern, to thereby cause the radiation scanner 20 to perform scanning and irradiation with the second laser light L2 formed into the second radiation shape LS2. The scanner control unit 22 then acquires the mirror angle (light transmission control angle) of the galvano mirror 44a corresponding to each of the second measurement points S2 which are points within the irradiated measurement-target area A, and transmits the mirror angle to the information generation unit 32. In this manner, the laser radar device 10 is set to be in a mode for scanning the measurement-target area A with the second laser light L2 of which the radiation shape is formed into the second radiation shape LS2, and receiving the second reflected light R2 from the measurement-target area A, and advances the process to step S28.

In the light reception unit, after the radiation shape control unit 18 performs the process of step S24 or step S26, the light receiving element 26 receives the reflected light R from the measurement-target area A to output a received signal based on the first laser light L1 or the second laser light L2 included in the reflected light R to the amplifier circuit 28, and the amplifier circuit 28 converts the received signal which is output by the light receiving element 26 from a current signal to a voltage signal to output the converted received signal to the distance calculation unit 30 (step S28).

The distance calculation unit 30 calculates the distance information of each of the first measurement points S1 or each of the second measurement points S2 in the measurement-target area A, on the basis of the received signal which is output from the amplifier circuit 28 when the light reception unit performs the process of step S28 (step S30). Specifically, the distance calculation unit 30 acquires the pulsed emission synchronizing signal transmitted from the light source control unit 14 and the received signal which is output from the amplifier circuit 28, measures a time which will be taken until the first laser light L1 or the second laser light L2 is emitted and then the reflected light R is received on the basis of the emission synchronizing signal and the received signal, and calculates a distance to each of the first measurement points S1 or each of the second measurement points S2 in the measurement-target area A in which the first laser light L1 or the second laser light L2 is reflected on the basis of this measurement time. The distance calculation unit 30 transmits the calculated distance information to the information generation unit 32. The distance calculation unit 30 may transmit light reception intensity included in the received signal, together with the distance information, to the information generation unit 32 in association with the distance information.

In addition, the distance calculation unit 30 calculates the position information in the horizontal direction X of each of the first measurement points S1 or each of the second measurement points S2 in the measurement-target area A, on the basis of the received signal which is output from the amplifier circuit 28. Specifically, the distance calculation unit 30 acquires the pixel information (number) of the light reception cell 26a in which the reflected light R is received, calculates the position information in the horizontal direction X of each of the first measurement points S1 or each of the second measurement points S2 from this pixel information, and transmits this position information to the information generation unit 32.

The information generation unit 32 receives the distance information transmitted when the distance calculation unit 30 performs the process of step S30. In addition, the information generation unit 32 receives the information of the mirror angle corresponding to each of the first measurement points S1 or each of the second measurement points S2 from the scanner control unit 22, and receives the position information in the horizontal direction X of each of the first measurement points S1 or each of the second measurement points S2 from the distance calculation unit 30. The information generation unit 32 generates three-dimensional information of the measurement-target area A on the basis of the distance information from the distance calculation unit 30 and the information (position information) of the mirror angle from the scanner control unit 22 or the position information from the distance calculation unit 30 (step S32). Here, in a case where the radiation shape of a beam of the laser light L is formed into the first radiation shape LS1, the information generation unit 32 may use only the information of the mirror angles of the galvano mirrors 42a and 44a from the scanner control unit 22 as the position information, and may use the information (position information) of the mirror angle of the galvano mirror 44a from the scanner control unit 22 and the position information from the distance calculation unit 30, combined with each other, as the position information. In a case where the radiation shape of a beam of the laser light L is formed into the second radiation shape LS2, the information generation unit 32 uses the information (position information) of the mirror angle of the galvano mirror 44a from the scanner control unit 22 and the position information from the distance calculation unit 30, combined with each other, as the position information.

The information generation unit 32 can transmit the generated three-dimensional information of the measurement-target area A to the external device 34, to thereby store the three-dimensional information in the external device 34 or display the three-dimensional information on a display.

As described above, the laser radar device 10 controls the radiation shape into the first radiation shape LS1 having a small radiation surface area in a case where it is determined that the range of visibility in the radiation direction of the laser light L is in a state of being less than the threshold value and a case where it is determined that the range of visibility changes from a state of being equal to or greater than the threshold value to a state of being less than the threshold value, and controls the radiation shape into the second radiation shape LS2 having a large radiation surface area in a case where it is determined that the range of visibility in the radiation direction of the laser light L is in a state of being equal to or greater than the threshold value and a case where it is determined that the range of visibility changes from a state of being less than the threshold value to a state of being equal to or greater than the threshold value. Therefore, even in a case where the transmittance of a beam of laser light changes concomitant with changes in the outdoor environment, the laser radar device 10 makes it possible to detect an obstacle while limiting the power consumption of the device. In addition, the laser radar device 10 makes it possible to detect an obstacle in quick response to changes in the outdoor environment such as changes in the range of visibility. That is, in a case where the range of visibility is as small as less than the threshold value and a case where the range of visibility becomes as small as less than the threshold value, the laser radar device 10 scans and irradiates the measurement-target area A with the first laser light L1 formed into the first radiation shape LS1, and thus it is possible to improve signal intensity by increasing the irradiation power density of the first laser light L1 with which the measurement-target area A is irradiated. Thereby, it is possible to secure measurement performance of the measurement-target area A even under the environmental conditions in which the transmittance of the first laser light L1 is low, for example, a fog environment or a rain environment. On the other hand, in a case where the range of visibility is as large as equal to or greater than the threshold value and a case where the range of visibility becomes as large as equal to or greater than the threshold value, the laser radar device 10 scans and irradiates the measurement-target area A with the second laser light L2 formed into the second radiation shape LS2 in a direction perpendicular to the extending direction of the second radiation shape LS2, and thus it is possible to improve the three-dimensional measurement rate of the measurement-target area A, and to measure the measurement-target area A in a short period of time.

In addition, since the laser radar device 10 automatically switches the first radiation shape LS1 and the second radiation shape LS2 in threshold processing, an operator's determination and operation are not required. Meanwhile, the present invention is not limited thereto, and an operator confirms information of the range of visibility by the information of the range of visibility being displayed to the operator. Thereby, the first radiation shape LS1 and the second radiation shape LS2 may be manually switched.

Meanwhile, the laser radar device 10 is configured such that two threshold values, that is, the first threshold value and the second threshold value are provided in order to determine the range of visibility so that hysteresis remains when the radiation shape of the laser light L is switched. However, without being limited thereto, using one threshold value, it is determined that the range of visibility is set to be equal to or greater than the threshold value from less than the threshold value, and it is determined that the range of visibility is set to be less than the threshold value from equal to or greater than the threshold value, whereby the radiation shape of the laser light L may be switched so that hysteresis does not remain.

In the present embodiment, the laser radar device 10 is configured such that the radiation shape control unit 18 determines the range of visibility on the basis of the intensity of the received signal acquired from the amplifier circuit 28, but the present invention is not limited thereto. In a case where the laser radar device 10 is further provided with a visibility meter, information of the range of visibility measured and output by this visibility meter may be received, and this information of the range of visibility may be determined. In this case, it is possible to determine an objective range of visibility even under a situation such as during uprise of the laser radar device 10.

The laser radar device 10 can appropriately change the combination of the first radiation shape LS1 and the second radiation shape LS2 under the conditions in which the radiation surface area of the first radiation shape LS1 is smaller than the radiation surface area of the second radiation shape LS2. For example, the laser radar device 10 may form the second radiation shape LS2 in a surface shape extending in the horizontal direction X and the vertical direction Y, and not perform scanning in accordance with the second radiation shape LS2. In this case, it is possible to further improve a three-dimensional measurement rate of the measurement-target area A, and to measure the measurement-target area A in a shorter period of time.

The laser radar device 10 can also have a third radiation shape adopted therein, in addition to the first radiation shape LS1 and the second radiation shape LS2. In this case, the laser radar device 10 is configured such that a radiation shape is used which has a larger radiation surface area as the range of visibility, that is, transmittance increases, and that the measurement-target area A is measured. In a case where the third radiation shape is set to have a radiation surface area intermediate between the first radiation shape LS1 and the second radiation shape LS2, an illustration is shown in which the third radiation shape is formed into a line shape extending in the horizontal direction X by half the length of the second radiation shape LS2.

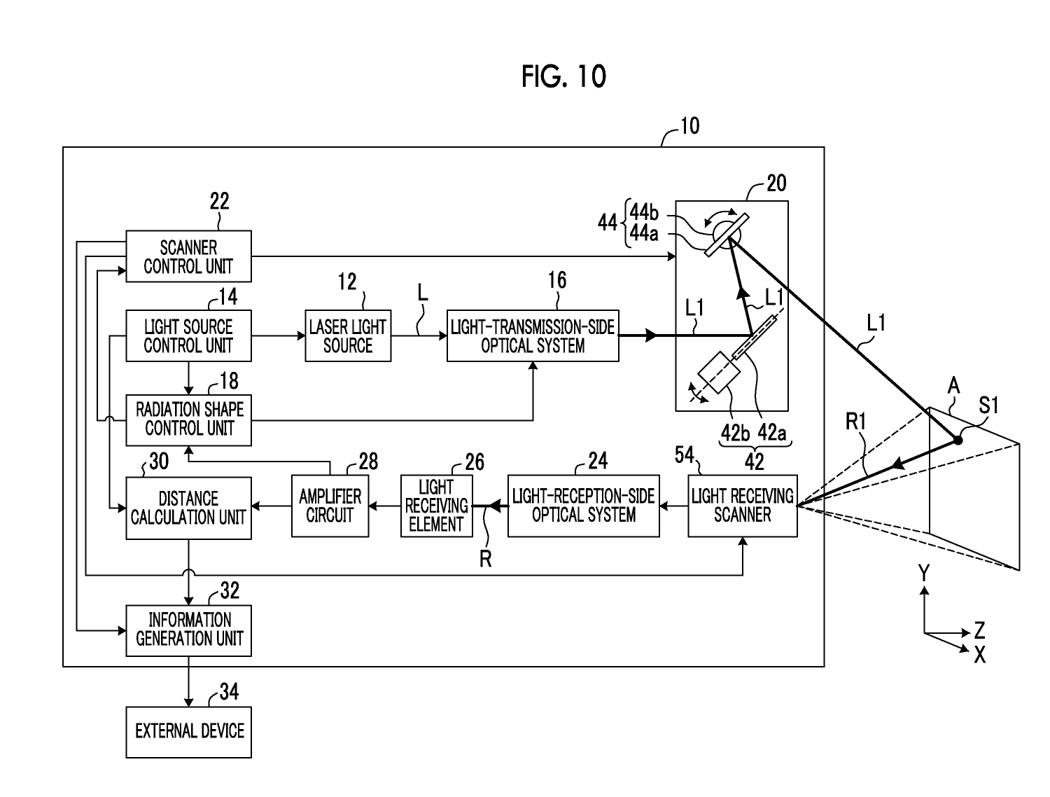

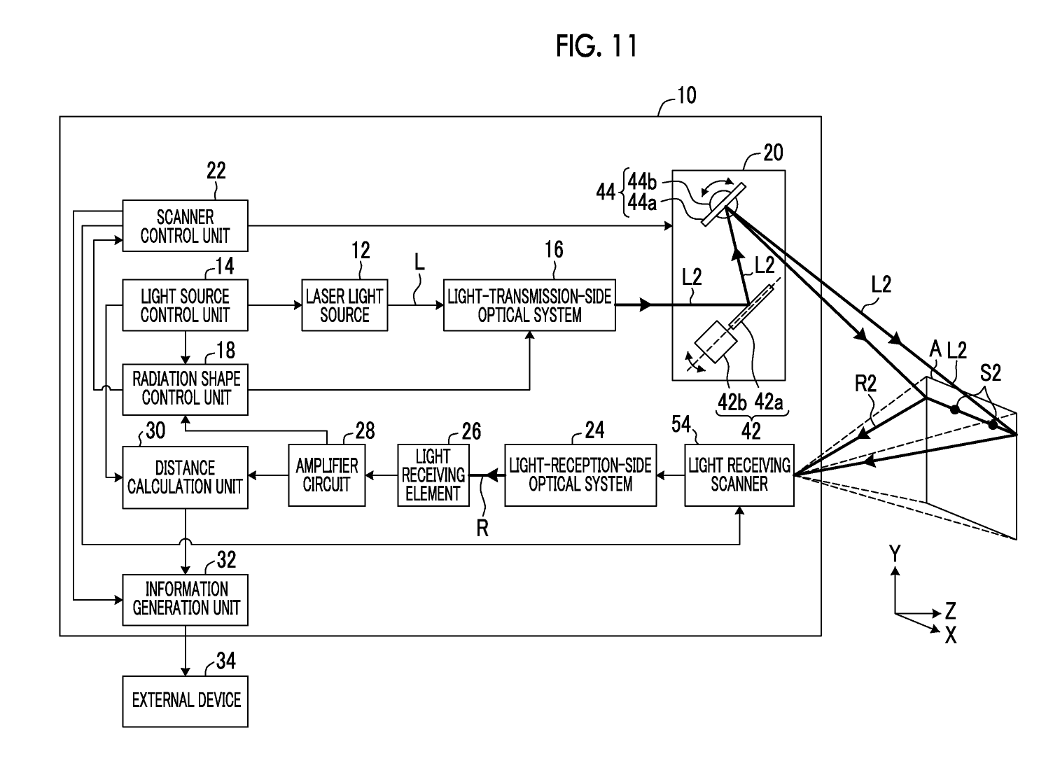

FIG. 10 is a schematic configuration diagram when a laser radar device 10 according to a second embodiment of the present invention forms the laser light L into the first radiation shape LS1 and performs light irradiation. FIG. 11 is a schematic configuration diagram when the laser radar device 10 according to the second embodiment of the present invention forms the laser light into the second radiation shape LS2 and performs light irradiation. The laser radar device 10 according to the second embodiment has a light receiving scanner 54 additionally provided on the incidence side of the first reflected light R1 or the second reflected light R2 of the light-reception-side optical system 24 in the laser radar device 10 according to the first embodiment. Accordingly, the laser radar device 10 according to the second embodiment is changed so that the scanner control unit 22 controls not only the radiation scanner 20 but also the light receiving scanner 54. In the laser radar device 10 according to the second embodiment, the same symbol group as that of the first embodiment is used in the same components as those of the first embodiment, and thus the detailed description thereof will not be given.

Similarly to the radiation scanner 20, the light receiving scanner 54 has a function of scanning the measurement-target area A two-dimensionally, and includes a horizontal scanning portion that performs scanning with the first reflected light R1 in the horizontal direction X and a vertical scanning portion that performs scanning with the first reflected light R1 or the second reflected light R2 in the vertical direction Y. Similarly to the radiation scanner 20, the horizontal scanning portion and the vertical scanning portion are constituted by, for example, a galvano scanner, and include a galvano mirror which is a planar mirror and a drive motor that trembles the mirror surface of the galvano mirror. The light receiving scanner 54 performs scanning by performing the same operation as that of the radiation scanner 20, and thus the detailed description of its operation will not be given. Meanwhile, in the present embodiment, a description has been given of a configuration in which the galvano scanner is used as an example of the horizontal scanning portion and the vertical scanning portion, but a polygon scanner having, for example, a polygon mirror may be used without being limited to this configuration.

The scanner control unit 22 in the laser radar device 10 according to the second embodiment also controls the operation of the light receiving scanner 54, in addition to the operation of the radiation scanner 20. The scanner control unit 22 controls operations so that the operation of the radiation scanner 20 and the operation of the light receiving scanner 54 correspond to each other. That is, the scanner control unit 22 controls the operation of the light receiving scanner 54 so as to correspond to the coordinates of each of the first measurement points S1 and each of the second measurement points S2 determined in accordance with control of the operation of the radiation scanner 20.

Specifically, the scanner control unit 22 receives the first shape information or the second shape information transmitted from the radiation shape control unit 18 with respect to not only the radiation scanner 20 but also the light receiving scanner 54, determines a scanning pattern on the basis of the first shape information or the second shape information which are received, and performs scanning on the basis of the determined scanning pattern. The scanner control unit 22 determines to perform scanning with the scanning pattern in the horizontal direction X and the vertical direction Y in a case where the first shape information is received from the radiation shape control unit 18 with respect to not only the radiation scanner 20 but also the light receiving scanner 54, and determines to perform scanning with the scanning pattern in the vertical direction Y in a case where the second shape information is received from the radiation shape control unit 18. In a case where scanning in the horizontal direction X and the vertical direction Y is performed and a case where scanning in the vertical direction Y is performed, the scanner control unit 22 controls the operation of the drive motor on the basis of a predetermined scanning pattern, with respect to not only the radiation scanner 20 but also the light receiving scanner 54.

The laser radar device 10 according to the second embodiment includes the light receiving scanner 54, and is configured such that the light receiving scanner 54 performs scanning on the light reception side of the reflected light R in accordance with the radiation scanner 20 performing scanning on the irradiation side of the laser light L. Therefore, even in a case where the light reception unit does not include a light reception region of the reflected light R condensed by the light-reception-side optical system 24, it is possible to receive the reflected light R of the entirety of the measurement-target area A.

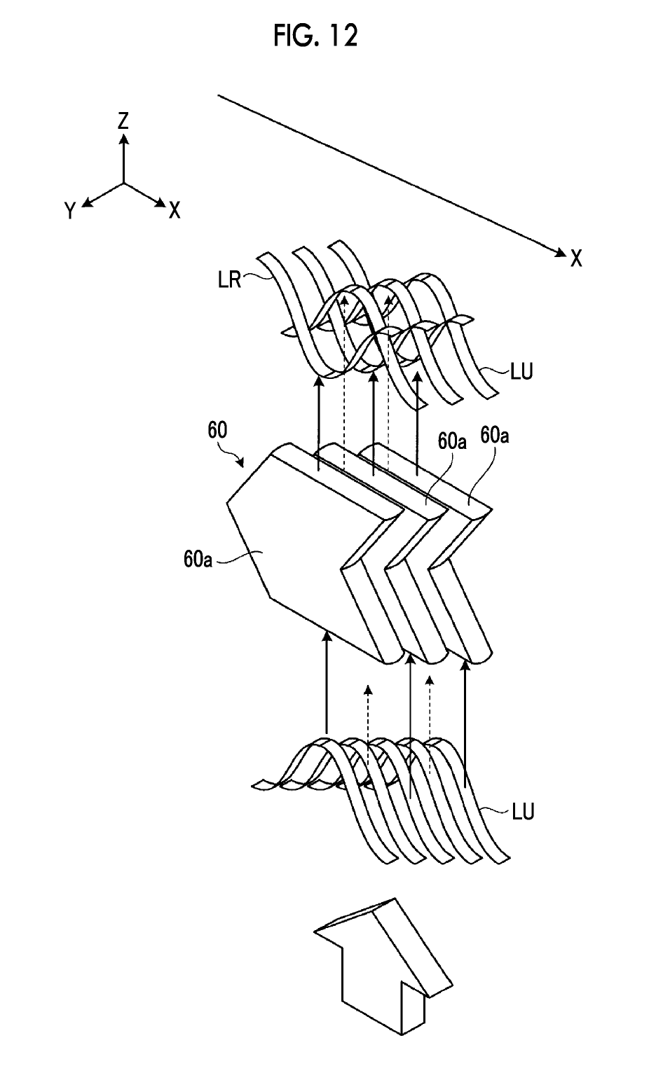

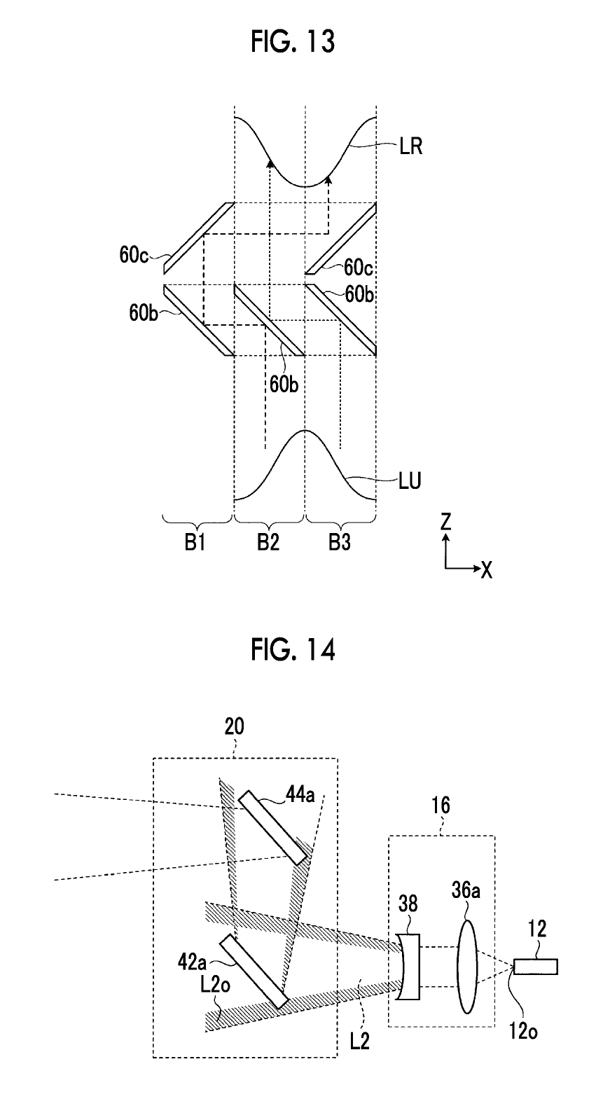

FIG. 12 is a schematic configuration diagram of an intensity distribution reduction mechanism 60 provided in a light-transmission-side optical system 16 of a laser radar device 10 according to a third embodiment of the present invention. FIG. 13 is a diagram illustrating the intensity distribution reduction mechanism 60. The laser radar device according to the third embodiment has the intensity distribution reduction mechanism 60 additionally provided in the light-transmission-side optical system 16 in the laser radar device 10 according to the first embodiment. In the laser radar device 10 according to the third embodiment, the same symbol group as that of the first embodiment is used in the same components as those of the first embodiment, and thus the detailed description thereof will not be given.

As shown in FIGS. 12 and 13, the intensity distribution reduction mechanism 60 is an optical mechanism, formed into a line shape, which reduces an intensity distribution in the direction of the line shape by causing normal distributed laser light LU having an intensity distribution in the direction of the line shape and inverted distributed laser light LR obtained by inverting this intensity distribution using an inversion optical system to superimpose each other. In the present embodiment, an example of the normal distributed laser light LU illustrated includes the second laser light L2, formed into the second radiation shape LS2 which is a line shape extending in the horizontal direction X, which has an intensity distribution of a Gaussian distribution (normal distribution) in the horizontal direction X, but there is no limitation thereto.

As shown in FIG. 12, the intensity distribution reduction mechanism 60 is configured such that a plurality of inversion optical systems 60a are arranged at intervals equivalent to a thickness t in a direction perpendicular to the radiation direction and the direction of the line shape of the second laser light L2 illustrated as the normal distributed laser light LU of the inversion optical system 60a. Here, the direction of the line shape of the second laser light L2 illustrated as the normal distributed laser light LU is equivalent to the horizontal direction X. Therefore, the direction of the line shape of the normal distributed laser light LU is called the horizontal direction X in the following description of the third embodiment. In addition, since the radiation direction of the second laser light L2 illustrated as the normal distributed laser light LU is equivalent to a Z direction (see FIGS. 1, 2, 6, 10, and 11), a direction perpendicular to the radiation direction of the second laser light L2 illustrated as the normal distributed laser light LU and the horizontal direction X which is the direction of the line shape is equivalent to the vertical direction Y in the present embodiment. Therefore, the radiation direction of the normal distributed laser light LU is called the Z direction in the following description of the third embodiment. In addition, the direction perpendicular to the radiation direction of the normal distributed laser light LU and the horizontal direction X which is the direction of the line shape is called the vertical direction Y in the following description of the third embodiment. In other words, the intensity distribution reduction mechanism is configured such that the plurality of inversion optical systems 60a having a thickness of t in the vertical direction Y are arranged in a state of being separated from each other by intervals of t along the vertical direction Y. In the present embodiment, the intensity distribution reduction mechanism 60 is configured such that both the thickness of the inversion optical system 60a and the interval therebetween are t, but there is no limitation thereto. In a case where the sum of the thicknesses of the plurality of inversion optical systems 60a in the vertical direction Y and the sum of the intervals between the plurality of inversion optical systems 60a in the vertical direction Y are substantially equivalent to each other, the intensity of the normal distributed laser light LU after having passed through the intensity distribution reduction mechanism 60 and the intensity of the inverted distributed laser light LR become substantially equivalent to each other, and thus it is possible to reduce the intensity distribution of the normal distributed laser light LU in the horizontal direction X. As in the present embodiment, it is preferable that the intensity distribution reduction mechanism 60 is configured such that both the thickness of the inversion optical system 60a and the interval therebetween are t. In this case, it is possible to more reliably reduce the intensity distribution of the normal distributed laser light LU in the horizontal direction X.

As shown in FIG. 13, the inversion optical system 60a includes three first mirror members 60b and two second mirror members 60c provided in the radiation direction of the normal distributed laser light LU with respect to two first mirror members 60b located on both ends among the three first mirror members 60b. The three first mirror members 60b are all disposed side by side in the horizontal direction X at an inclination of 45 degrees on one side (counterclockwise in FIG. 13) in the horizontal direction X which is the direction of the line shape with respect to the Z direction which is the radiation direction of the normal distributed laser light LU. Both the two second mirror members 60c are disposed at an inclination of 45 degrees on the other side (clockwise in FIG. 13) in the horizontal direction X which is the direction of the line shape with respect to the Z direction which is the radiation direction of the normal distributed laser light LU.

The three first mirror members 60b all are of such a length as to cover half the optical path width of the normal distributed laser light LU in the horizontal direction X, that is, have √2/2 times the length of the optical path width of the normal distributed laser light LU in the horizontal direction X. A first mirror member disposed at the center in the horizontal direction X among the three first mirror members 60b is disposed so as to cover one half region B2 at the optical path width of the normal distributed laser light LU in the horizontal direction X. A first mirror member disposed on one side (left side in FIG. 13) in the horizontal direction X among the three first mirror members 60b is disposed so as to cover a region B1 shifted from the one side at the optical path width of the normal distributed laser light LU in the horizontal direction X. A first mirror member disposed on the other side (right side in FIG. 13) in the horizontal direction X among the three first mirror members 60b is disposed so as to cover the other half region B3 at the optical path width of the normal distributed laser light LU in the horizontal direction X.

Both the two second mirror members 60c are of such a length as to cover half the optical path width of the normal distributed laser light LU in the horizontal direction X, that is, have √2/2 times the length of the optical path width of the normal distributed laser light LU in the horizontal direction X. A second mirror member out of the two second mirror members 60c disposed near one side (left side in FIG. 13) in the horizontal direction X is disposed so as to cover the region B1 shifted from the one side at the optical path width of the normal distributed laser light LU in the horizontal direction X. A second mirror member out of the two second mirror members 60c disposed near the other side (right side in FIG. 13) in the horizontal direction X is disposed so as to cover the other half region B3 at the optical path width of the normal distributed laser light LU in the horizontal direction X.

Reference will be made to FIG. 13 to describe a process in which the inversion optical system 60a inverts the intensity distribution of the normal distributed laser light LU to form the inverted distributed laser light LR. As shown in FIG. 13, the normal distributed laser light LU is formed into a line shape astride the region B2 and the region B3 in the horizontal direction X, and has an intensity distribution of a Gaussian distribution in the horizontal direction X. In addition, the optical path width of the normal distributed laser light LU straddles between the region B2 and the region B3. As shown in FIG. 13, the normal distributed laser light LU passing through the region B2 before passing through the inversion optical system 60a is sequentially reflected by the first mirror member 60b disposed at the center in the horizontal direction X, the first mirror member 60b and the second mirror member 60c disposed on one side (left side in FIG. 13) in the horizontal direction X, and the second mirror member 60c disposed on the other side (right side in FIG. 13) in the horizontal direction X, and passes through the region B3 after passing through the inversion optical system 60a. As shown in FIG. 13, the normal distributed laser light LU passing through the region B3 before passing through the inversion optical system 60a is sequentially reflected by the first mirror member 60b disposed on the other side (right side in FIG. 13) in the horizontal direction X and the first mirror member 60b disposed at the center in the horizontal direction X, and passes through the region B2 after passing through the inversion optical system 60a. Thereby, the inversion optical system 60a replaces half regions of the normal distributed laser light LU, that is, replaces one half region B2 and the other half region B3 of the normal distributed laser light LU with the region B3 and the region B2, respectively, whereby the intensity distribution of the normal distributed laser light LU is inverted, and thus it is possible to convert the normal distributed laser light into the inverted distributed laser light LR.

The intensity distribution reduction mechanism 60 is configured to be alternately provided with a region having a width of t in which the inversion optical system 60a is provided and a region having a width of t in which the inversion optical system 60a is not provided, in the vertical direction Y. Therefore, the intensity distribution reduction mechanism 60 can convert the normal distributed laser light LU into mixed laser light in which a beam of the inverted distributed laser light LR having a width of t obtained by inverting the intensity distribution of the normal distributed laser light LU using the inversion optical system 60a and the normal distributed laser light LU having a width of t are alternately lined up in the vertical direction Y. Here, the mixed laser light is laser light of which the intensity distribution in the horizontal direction X is reduced since the normal distributed laser light LU and the inverted distributed laser light LR mutually cancel intensity distributions in the horizontal direction X. In this manner, the intensity distribution reduction mechanism 60 reduces the intensity distribution of the normal distributed laser light LU in the horizontal direction X.

The laser radar device 10 according to the third embodiment is configured such that the light-transmission-side optical system 16 is provided with the intensity distribution reduction mechanism 60, and thus the intensity distribution reduction mechanism 60 can reduce the intensity distribution of the normal distributed laser light LU in the horizontal direction X, that is, can reduce the intensity distribution of the laser light formed into a line shape in the direction of the line shape. Therefore, it is possible to improve the accuracy of detection of an obstacle in a case where the laser light formed into a line shape is used.

The laser radar device 10 according to the third embodiment reduces an intensity distribution in a line direction, in the normal distributed laser light LU after being formed into a line shape. The laser radar device 10 according to the third embodiment may reduce an intensity distribution in a line direction, in the normal distributed laser light before being formed into a line shape, without being limited thereto. Even in this case, the same effect as that in a case where an intensity distribution in a line direction is reduced in the normal distributed laser light LU after being formed into a line shape is obtained.

FIGS. 14, 15 and 16 are all diagrams schematically illustrating a light-transmission-side optical system 16 and a radiation scanner 20 of a laser radar device 10 according to a fourth embodiment of the present invention. The laser radar device 10 according to the fourth embodiment has the insertion-extraction optical element 38, provided in the light-transmission-side optical system 16, changed to an insertion-extraction optical element 62 in the laser radar device 10 according to the first embodiment. Accordingly, the laser radar device 10 according to the fourth embodiment is changed so that an optical element constituting the basic optical system 36 and the radiation scanner 20 is disposed away from a region in which the second laser light L2 is condensed by the insertion-extraction optical element 62. In the laser radar device 10 according to the fourth embodiment, the same symbol group as that of the first embodiment is used in the same components as those of the first embodiment, and thus the detailed description thereof will not be given.

FIG. 14 is a diagram illustrating an event in which there may be a concern of being generated in the light-transmission-side optical system 16 due to a case where the radiation surface areas of the first laser light L1 and the second laser light L2 radiated by the radiation scanner 20 are restricted, in a case where the optical systems of the radiation scanner 20, that is, the galvano mirrors 42a and 44a are required to be reduced in size in the laser radar device 10 according to the first embodiment, or a case where it is required to limit the inertia of the galvano mirrors 42a and 44a trembled in order to secure the speed and accuracy of scanning of the radiation scanner 20. As shown in FIG. 14, in a case where the laser radar device 10 according to the first embodiment radiates the laser light L from the radiation port 12o of the laser light source 12, and the laser light is caused to pass through the optical element 36a included in the basic optical system 36 in the light-transmission-side optical system 16 and the insertion-extraction optical element 38 located at its insertion position and is formed into the second laser light L2, there may be a concern that an outer circumferential portion L2o of a beam of the second laser light L2 is not able to be used due to the formation of shading by not falling within the galvano mirrors 42a and 44a of the radiation scanner 20.

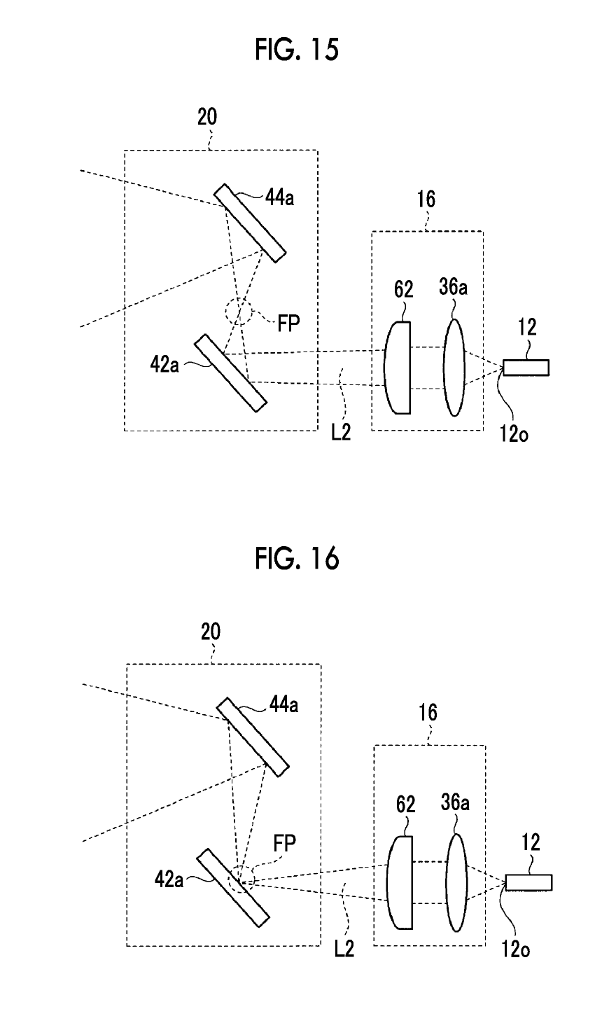

FIG. 15 is a diagram illustrating a form for avoiding the event shown in FIG. 14, and a diagram illustrating a schematic configuration of the light-transmission-side optical system 16 and the radiation scanner 20 of the laser radar device 10 according to the fourth embodiment of the present invention. The laser radar device 10 according to the fourth embodiment includes the insertion-extraction optical element 62 instead of the insertion-extraction optical element 38. In the present embodiment, the insertion-extraction optical element 62 is an element that condenses a beam of the laser light L in the horizontal direction X. The insertion-extraction optical element 62 condenses a beam of the first laser light L1 formed into the first radiation shape LS1 in the basic optical system 36 in the horizontal direction X, and thus a radiation shape when radiated from the radiation scanner 20 is switched so as to become the second radiation shape LS2 diffused in a line shape while holding the radiation surface area of the second laser light L2 radiated by the radiation scanner 20 small. In the present embodiment, the insertion-extraction optical element 62 is a single optical element, but may have a plurality of optical elements combined with each other without being limited thereto. The insertion-extraction optical element 62 makes it possible to appropriately select the second radiation shape LS2 by selecting the shape and configuration thereof. The insertion-extraction optical element 62 is constituted by, for example, a cylindrical convex lens in which the incidence-side curved surface of the first laser light L1 is planar, and the emission-side curved surface of laser light serving as the second laser light L2 formed into the second radiation shape LS2 when condensed in the horizontal direction X and radiated from the radiation scanner 20 is convex.

Similarly to the insertion-extraction optical element 38, the insertion-extraction optical element 62 has a drive motor connected thereto which drives the insertion-extraction optical element 62 between its insertion position and its extraction position. Similarly to the drive motor 38M, this drive motor is connected to the radiation shape control unit 18, and moves the insertion-extraction optical element 62 to its insertion position on the basis of an insertion command which is transmitted from the radiation shape control unit 18. In addition, similarly to the drive motor 38M, this drive motor moves the insertion-extraction optical element 62 to its extraction position on the basis of an extraction command which is transmitted from the radiation shape control unit 18. That is, the light-transmission-side optical system 16 switches a radiation shape for forming a beam of the laser light L between the first radiation shape LS1 and the second radiation shape LS2 by moving the insertion-extraction optical element 62 on the basis of the insertion command and the extraction command which are transmitted from the radiation shape control unit 18 to this drive motor.

Since the laser radar device 10 according to the fourth embodiment of the present invention has the configuration as shown in FIG. 15, a beam of the second laser light L2 is temporarily condensed by the insertion-extraction optical element 62, and the second laser light L2 having passed through the radiation scanner 20 after condensation can be formed into the second radiation shape LS2 by diffusing the light beam using the radiation scanner 20. Therefore, even in a case where the radiation surface area of the second laser light L2 radiated by the radiation scanner 20, as shown in FIG. 14, is restricted, an event is not caused in which shading is formed by the outer circumferential portion L2o of a beam of the second laser light L2 not falling within the galvano mirrors 42a and 44a of the radiation scanner 20. That is, the laser radar device 10 according to the fourth embodiment of the present invention can efficiently use the entirety of a beam of the second laser light L2 diffused as a result by the insertion-extraction optical element 62.

As shown in FIG. 16, in a case where the galvano mirror 42a which is one of optical elements constituting the radiation scanner 20 is disposed in a region FP having the laser light L condensed therein, there may be a concern that the radiation scanner 20 in the laser radar device 10 according to the fourth embodiment of the present invention is damaged due to the condensed laser light L. For this reason, as shown in FIG. 15, the radiation scanner 20 in the laser radar device 10 according to the fourth embodiment of the present invention has the galvano mirrors 42a and 44a which are optical elements constituting the radiation scanner 20 disposed away from the region FP in which the laser light L is condensed. Thereby, the laser radar device according to the fourth embodiment of the present invention can prevent the galvano mirrors 42a and 44a from being damaged due to the condensed laser light L.

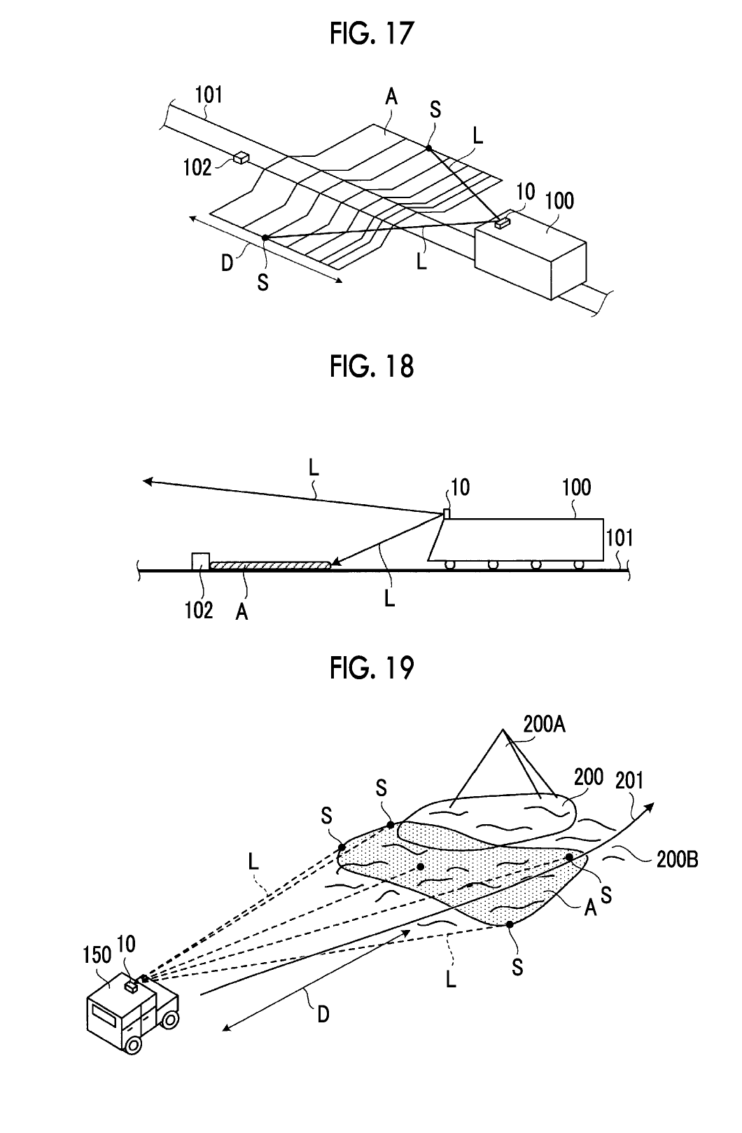

Next, an application example of the laser radar device 10 according to the first to fourth embodiments will be described. FIG. 17 is a perspective view illustrating a configuration in which the laser radar device 10 is mounted onto a train 100 traveling on a railroad track 101, and FIG. 18 is a side-view diagram illustrating a configuration in which the laser radar device 10 is mounted onto the train 100 traveling on the railroad track 101. In this application example, the laser radar device 10 is mounted onto the train 100 which is a traveling body. The train 100 travels on a railroad track 101, and may be configured to be driven by an operator's steering, or configured to be automatically operated by a computer.

The laser radar device 10 is provided at the upper front of the train 100, and is configured to monitor the measurement-target area A which is set in the forward traveling direction of the train 100. Specifically, the measurement-target area A is set on a traveling road surface in a forward traveling direction including the railroad track 101 over a predetermined distance D (for example, 300 to 500 m) from the train 100, and the measurement-target area A is updated at any time in accordance with the traveling of the train 100. The laser radar device 10 scans and irradiates this measurement-target area A with the first laser light L1 or the second laser light L2 (indicated by symbol L collectively in FIGS. 17 and 18) in accordance with the range of visibility in the forward traveling direction of the train 100, and generates three-dimensional information of the measurement-target area A on the basis of the distance information and the position information of each of the first measurement points S1 or each of the second measurement points S2 (indicated by symbol S collectively in FIGS. 17 and 18).

The train 100 includes a computer that acquires the three-dimensional information of the measurement-target area A output from the laser radar device 10, as the external device 34, and a display that displays the shape of the measurement-target area A drawn by this computer on the basis of the three-dimensional information, which are not shown in the drawing. The computer and the display are disposed in an operator's cab of the train 100.

In such a configuration, the three-dimensional information generated by the laser radar device 10 is output to the computer of the train 100 at any time, and is displayed on the display through this computer. Therefore, for example, even in a case where an obstacle 102 is present on the railroad track 101, the shape of the measurement-target area A including the obstacle 102 is displayed on the display, driving support for a driver can be realized. In addition, even in a case where not only the shape is displayed on the display, but also the change of the shape in a traveling direction in the measurement-target area A exceeds a predetermined threshold value, an attention warning may be issued on the assumption that the obstacle 102 is more likely to be present.

In addition, in a configuration in which the train 100 is automatically driven by the computer, in a case where the obstacle 102 is present on the railroad track 101 on the basis of the three-dimensional information generated by the laser radar device 10, it is possible to realize safe automatic driving by stopping the train 100.

FIG. 19 is a perspective view illustrating a configuration in which the laser radar device 10 is mounted into a vehicle 150. In this application example, the laser radar device 10 is mounted onto the vehicle 150 which is a traveling body. The vehicle 150 freely travels on a road surface, and may be configured to be driven by a driver's steering, or configured to be automatically driven by the computer.

The laser radar device 10 is provided at the upper front of the vehicle 150, and is configured to monitor the measurement-target area A which is set on a landform 200 in the forward traveling direction of the vehicle 150. Specifically, the measurement-target area A is set on the surface of the landform 200 in a forward traveling direction over a predetermined distance D (for example, 100 m) from the vehicle 150, and the measurement-target area A is updated at any time in accordance with the traveling of the vehicle 150. The laser radar device 10 scans and irradiates this measurement-target area A with the first laser light L1 or the second laser light L2 (indicated by symbol L collectively in FIG. 19) in accordance with the range of visibility in the forward traveling direction of the train 100, and generates three-dimensional information of the measurement-target area A (landform 200) on the basis of the distance information and the position information of each of the first measurement points S1 or each of the second measurement points S2 (indicated by symbol S collectively in FIG. 19). In FIG. 19, the landform 200 is described as including an apex portion 200A having large undulations and a flattened portion 200B having small undulations.

The vehicle 150 includes a navigation device, not shown in the drawing, which performs route guidance of the vehicle 150 as the external device 34 (FIG. 1). This navigation device includes a navigation control unit that controls the entire navigation device and a display that displays a route (map information), and the three-dimensional information of the measurement-target area A is output to the navigation control unit. The navigation device sets a route 201 through the flattened portion 200B having small undulations while avoiding the apex portion 200A having large undulations, on the basis of the three-dimensional information of the measurement-target area A. According to such a configuration, even in a case where the vehicle travels along the landform 200 having severe undulations, it is possible to travel along the route 201 including, preferably, the flattened portion 200B, and to realize driving support for a driver.

In addition, in a configuration in which the vehicle 150 is automatically driven by the computer, it is possible to realize safe automatic driving by traveling along the route 201 including, preferably, the flattened portion 200B, on the basis of the three-dimensional information generated by the laser radar device 10.

Since the above-described laser radar device 10 is mounted onto a traveling body such as the train 100 or the vehicle 150, it is possible to acquire three-dimensional information of the traveling route of a traveling body such as the train 100 or the vehicle 150 at all times, and to perform operation support of the train 100 or the vehicle 150. Specifically, in a case where the range of visibility in the forward traveling direction of a traveling body such as the train 100 or the vehicle 150 is large, the above-described laser radar device 10 controls the radiation shape of the laser light L into the second radiation shape LS2, and thus it is possible to acquire the three-dimensional information early, and to suitably support traveling at high speed. In addition, in a case where the range of visibility in the forward traveling direction of a traveling body such as the train 100 or the vehicle 150 is small, the above-described laser radar device 10 controls the radiation shape of the laser light L into the first radiation shape LS1, and thus it is possible to secure the measurement performance of the measurement-target area A, and to suitably support traveling even in a case where the range of visibility in a traveling direction is small. Meanwhile, since a traveling body such as the train 100 or the vehicle 150 travels at low speed in a case where the range of visibility in the forward traveling direction of a traveling body such as the train 100 or the vehicle 150 is small, the above-described laser radar device 10 takes time to acquire the three-dimensional information in order to control the radiation shape of the laser light L into the first radiation shape LS1 as compared with a case of control into the second radiation shape LS2, but does not interfere with operation support of the train 100 or the vehicle 150.

In the above-described application example, a configuration has been described in which the laser radar device 10 is mounted onto the traveling body of the train 100 or the vehicle 150, but there is no limitation thereto in a case of a self-propelled traveling body. In addition, in the above-described application example, the laser radar device 10 is mounted onto a traveling body, but a configuration may be used in which the laser radar device is disposed on, for example, a strut disposed upright at the side of a crossover point, a railroad crossing or the like having the measurement-target area A set therein so as to look down at the measurement-target area A, the measurement-target area A is scanned and irradiated in accordance with a radiation shape with the first laser light L1 or the second laser light L2 in accordance with the range of visibility in the direction of the measurement-target area, and the first reflected light R1 or the second reflected light R2 of objects (for example, moving objects such as a pedestrian, a bicycle, a two-wheeled automobile, or an automobile, stationary objects such as a building, a guardrail, or a tree, and the like) within the measurement-target area A is received, to thereby generate three-dimensional information of these objects.

### REFERENCE SIGNS LIST

10: laser radar device
12: laser light source
12o: radiation port
14: light source control unit
16: light-transmission-side optical system
18: radiation shape control unit
20: radiation scanner
22: scanner control unit
24: light-reception-side optical system
26: light receiving element
26a: light reception cell
28: amplifier circuit
30: distance calculation unit
32: information generation unit
34: external device
36: basic optical system
36a: optical element
38, 62: insertion-extraction optical element
38M: drive motor
42: horizontal scanning portion
44: vertical scanning portion
42a, 44a: galvano mirror
42b, 44b: drive motor
46: light-reception-side lens
48: relay lens
50: condensing lens
50a: curved surface
50b: planar surface
52: line sensor array
54: light receiving scanner
60: intensity distribution reduction mechanism
60a: inversion optical system
60b: first mirror member
60c: second mirror member
100: train (traveling body)
101: railroad track
102: obstacle
150: vehicle (traveling body)
200: landform
200A: apex portion
200B: flat portion
201: route
A: measurement-target area
Aa: division area
B1, B2, B3: region
C: curved line
D: predetermined distance
L: laser light
L1: first laser light
L2: second laser light
LS1: first radiation shape
LS2: second radiation shape
LU: normal distributed laser light
LR: inverted distributed laser light
R: reflected light
R1: first reflected light
R2: second reflected light
S: measurement point
S1: first measurement point
S2: second measurement point
X: horizontal direction (first direction)
Y: vertical direction (second direction)

1-13. (canceled)

14. A laser radar device comprising:
a laser light source;
a light-transmission-side optical system that forms laser light which is emitted from the laser light source into a first radiation shape or a second radiation shape having a larger radiation surface area than that of the first radiation shape;
a radiation shape control unit that controls the light-transmission-side optical system to thereby control a radiation shape for forming the laser light into the first radiation shape or the second radiation shape;
a radiation scanner that scans and irradiates a measurement-target area in accordance with the radiation shape with the laser light formed by the light-transmission-side optical system;
a light-reception-side optical system that receives and condenses reflected light which is reflected from the measurement-target area;
a light reception unit that receives the reflected light condensed by the light-reception-side optical system, and outputs a received signal based on laser light included in the received reflected light; and
an information generation unit that generates three-dimensional information of the measurement-target area on the basis of the received signal which is output by the light reception unit,
wherein the light-transmission-side optical system includes an insertion-extraction optical element that switches a state of being disposed on an optical path of the laser light and a state of not being disposed thereon, to thereby switch the radiation shape of the laser light between the first radiation shape and the second radiation shape, and the light-transmission-side optical system forms the radiation shape into the first radiation shape in a state where the insertion-extraction optical element is not disposed on the optical path of the laser light, and forms the radiation shape into the second radiation shape by the insertion-extraction optical element being disposed on the optical path,
the insertion-extraction optical element is an element that condenses a beam of the laser light, and forms the laser light which is transmitted into the second radiation shape by diffusing the light beam after condensation, and
the radiation scanner has an optical element constituting the radiation scanner disposed away from a region in which the laser light is condensed.

15. The laser radar device according to claim 14, further comprising a surrounding environment detection unit that detects a range of visibility in a radiation direction of the laser light,
wherein the radiation shape control unit controls the radiation shape into the first radiation shape in a case where it is determined that the range of visibility in the radiation direction of the laser light detected by the surrounding environment detection unit is less than a threshold value, and controls the radiation shape into the second radiation shape in a case where it is determined that the range of visibility in the radiation direction of the laser light is equal to or greater than the threshold value.

16. The laser radar device according to claim 14,
wherein the light reception unit transmits information of an intensity of the received signal to the radiation shape control unit, and
the radiation shape control unit measures the range of visibility in the radiation direction of the laser light on the basis of the information of an intensity of the received signal, changes the radiation shape from the first radiation shape to the second radiation shape in a case where a peak value of an intensity of the received signal is set to be equal to or greater than a first threshold value in a state where the radiation shape of the laser light is formed into the first radiation shape and irradiation is performed, and changes the radiation shape from the second radiation shape to the first radiation shape in a case where the intensity of the received signal at a predetermined position on an end portion of the light reception unit is set to be less than a second threshold value in a state where the radiation shape of the laser light is formed into the second radiation shape and irradiation is performed.

17. The laser radar device according to claim 14,
wherein the first radiation shape is a dot shape, and
the radiation scanner scans and irradiates the measurement-target area with the laser light formed into the dot shape which is the first radiation shape, in a first direction of the measurement-target area and a second direction orthogonal to the first direction.

18. The laser radar device according to claim 14,
wherein the second radiation shape is a line shape extending in a first direction of the measurement-target area, and
the radiation scanner scans and irradiates the measurement-target area with the laser light formed into the line shape which is the second radiation shape, in a second direction orthogonal to the first direction.

19. The laser radar device according to claim 18,
wherein the light-transmission-side optical system is configured such that an inversion optical system that inverts an intensity distribution of the laser light before or after being formed into a line shape in a direction of the line shape includes a plurality of intensity distribution reduction mechanisms arranged at intervals equivalent to a thickness of the inversion optical system in a direction perpendicular to a radiation direction of the laser light and the direction of the line shape, and
the inversion optical system includes:
three first mirror members which are disposed at an inclination of 45 degrees on one side in the direction of the line shape with respect to the radiation direction of the laser light, are of such a length as to cover half an optical path width of the laser light in the direction of the line shape, are lined up in the direction of the line shape, and are respectively disposed so that one first mirror member covers a region shifted from the one side at the optical path width of the laser light in the direction of the line shape, so that one first mirror member covers one half region at the optical path width of the laser light in the direction of the line shape, and so that one first mirror member covers the other half region on an opposite side to the one side at the optical path width of the laser light in the direction of the line shape; and
two second mirror members which are provided on a side in the radiation direction of the laser light with respect to two of the first mirror members located on both ends among the three first mirror members, are disposed at an inclination of 45 degrees on the other side in the direction of the line shape with respect to the radiation direction of the laser light, and are of such a length as to cover half the optical path width of the laser light in the direction of the line shape.

20. The laser radar device according to claim 14,
wherein the light reception unit includes a light reception region of the reflected light condensed by the light-reception-side optical system.

21. The laser radar device according to claim 14, further comprising a light receiving scanner that receives the reflected light reflected from the measurement-target area while performing scanning with the reflected light in accordance with the radiation shape.

22. A traveling body comprising the laser radar device according to claim 14.

23. A laser radar device comprising:
a laser light source;
a light-transmission-side optical system that forms laser light which is emitted from the laser light source into a first radiation shape or a second radiation shape having a larger radiation surface area than that of the first radiation shape;
a radiation shape control unit that controls the light-transmission-side optical system to thereby control a radiation shape for forming the laser light into the first radiation shape or the second radiation shape;
a radiation scanner that scans and irradiates a measurement-target area in accordance with the radiation shape with the laser light formed by the light-transmission-side optical system;
a light-reception-side optical system that receives and condenses reflected light which is reflected from the measurement-target area;
a light reception unit that receives the reflected light condensed by the light-reception-side optical system, and outputs a received signal based on laser light included in the received reflected light; and
an information generation unit that generates three-dimensional information of the measurement-target area on the basis of the received signal which is output by the light reception unit,
wherein the second radiation shape is a line shape extending in a first direction of the measurement-target area,
the radiation scanner scans and irradiates the measurement-target area with the laser light formed into the line shape which is the second radiation shape, in a second direction orthogonal to the first direction,
the light-transmission-side optical system is configured such that an inversion optical system that inverts an intensity distribution of the laser light before or after being formed into a line shape in a direction of the line shape includes a plurality of intensity distribution reduction mechanisms arranged at intervals equivalent to a thickness of the inversion optical system in a direction perpendicular to a radiation direction of the laser light and the direction of the line shape, and
the inversion optical system includes:
three first mirror members which are disposed at an inclination of 45 degrees on one side in the direction of the line shape with respect to the radiation direction of the laser light, are of such a length as to cover half an optical path width of the laser light in the direction of the line shape, are lined up in the direction of the line shape, and are respectively disposed so that one first mirror member covers a region shifted from the one side at the optical path width of the laser light in the direction of the line shape, so that one first mirror member covers one half region at the optical path width of the laser light in the direction of the line shape, and so that one first mirror member covers the other half region on an opposite side to the one side at the optical path width of the laser light in the direction of the line shape; and
two second mirror members which are provided on a side in the radiation direction of the laser light with respect to two of the first mirror members located on both ends among the three first mirror members, are disposed at an inclination of 45 degrees on the other side in the direction of the line shape with respect to the radiation direction of the laser light, and are of such a length as to cover half the optical path width of the laser light in the direction of the line shape.
